(19) United States
(12) Patent Application Publication
(10) Pub. No.: US 2005/0027572 A1
(43) Pub. Date: Feb. 3, 2005

(54) System and method to evaluate crop insurance plans

(76) Inventor: Richard D.. Goshert, Columbia City, IN (US)

Correspondence Address: RANDALL J. KNUTH P.C., 4921 DESOTO DRIVE, FORT WAYNE, IN, 46815, US

(21) Appl. No.: 10/687,375

(22) Filed: Oct. 15, 2003

Related U.S. Application Data
(60) Provisional application No. 60/418,929, filed on Oct. 16, 2002.

(51) Int. Cl. G06F 17/60

(52) U.S. Cl. 705/4

(57) ABSTRACT

A system includes a comparator to determine and compare the relative historical performance of various crop insurance plans. The comparator utilizes historical information including actuarial data, historical price data, and historical yield data. The historical performance comparison is made under various selected scenarios reflecting different selections made by the user in connection with various crop insurance plan variables, such as price election, coverage level, and protection level. An options analyzer allows the user to define hypothetical insurance plan scenarios that are employed to determine a performance projection. The assumptions can relate to standard insurance plan selections or user-specified values. A best-case scenario can be computed that allows continuous variation of any selected combination of insurance plan variables until the performance criteria is satisfied.

### CROSS-REFERENCE TO RELATED APPLICATIONS

This application claims the benefit of U.S. Provisional Application Ser. No. 60/418,929 filed Jan. 6, 2003.

### BACKGROUND OF THE INVENTION

1. Field of the Invention

The present invention relates to insurance plans covering agricultural commodities, and, more particularly, to a system, methodology, and computer program product to review, evaluate, test and analyze crop insurance plans.

2. Description of the Related Art

The underwriting and administration of crop insurance is a heavily regulated and highly complex industry that can feature severe unpredictability in terms of assessing and managing risk for both the farmer and the insurance agent. A typical policy relies upon a confluence of factors and variables to ultimately determine the precise coverage available under a specific plan. For example, certain policies require the use of county-based price and yield data, harvest price, and government-issued commodity pricing information to complete the various policy formulations needed to compute final liability and indemnification, if applicable.

The Federal Crop Insurance Corporation (FCIC) has been chartered by Congress to direct and authorize the development of private crop insurance plans serving the agricultural community. The FCIC, for example, acts as the reinsuring entity for such private plans. Any authorized agri-peril plans must therefore conform to the underwriting and actuarial standards established and promulgated by the FCIC.

However, there has been a long-standing problem in the crop insurance business surrounding the complexity and variation of products. For example, any underwriting and actuarial changes required by the FCIC must be reflected in the corresponding policies, requiring continuous monitoring and updating of the policies. Additionally, the vast amount of data that is typically needed to write the specific policy provisions must be compiled and assembled from various sources. For example, policies typically must access information from databases describing policyholder data, actual production histories, insurance policy provisions, map information, rate tables, crop lists, type and practice information, and FCIC underwriting standards.

The effort and requirements needed to attain an adequate level of information access and level of plan servicing requires vast amounts of paper documents including county plat maps, county rating maps, county actuarial references and detail, county coverage rating books, hail reference manuals, and hail quoting catalogs, for example. The upkeep, management, storage, and transportation of all this material is a major restriction to where an individual would be able to work relative to the client community.

Moreover, the ability to issue quotes in a timely and accurate manner is compromised not only by the volume of data that must be processed, but by the difficulty in computing the various relevant calculations such as premium, rate, liability, and indemnification. Customary practice involves performing a series of manual calculations to render a quote. However, not only is such a quotation practice not feasible as applied to a single scenario, but practically impossible if a farmer or agent desires to compute insurance plan performance under various hypothetical scenarios across several types of plans and carriers.

A detailed understanding of each and every product is needed to properly sell and service crop insurance. The ability of any individual to not only understand but properly quote every available product has been limited to a very small group of highly trained agents. The extensive mathematical formulas required to determine premiums for most new products can only be done feasibly using a computer. As a result, it has become common practice for agents to simply focus on a few if not a single product and thereby sell only a limited number of policies.

Other problems surround the constant variation of data having a direct impact on the accuracy and completeness of crop insurance product costs, performance, and coverage. Many products are now based on Board of Trade commodity prices and fluctuate throughout the sales seasons. Moreover, government agencies release updates to rating data, yield data, actuarial updates, for example, on a regular basis. In the absence of constant vigilance and monitoring, an agent cannot stay current all the changes and properly quote and service crop producers.

It has therefore become difficult for individual producers and farmers to undertake a highly reliable and completely accurate financial analysis and projection of their crop business due to the limited availability of industry-wide insurance quotations. A need exists to provide farmers with an analysis and evaluation tool that offers farmers the opportunity to review the performance of a greater number of insurance plan choices and enables farmers to optimize their business performance by determining the proper combination of user-specifiable selections and options.

### SUMMARY OF THE INVENTION

According to the present invention, there is provided a machine, process, and article of manufacture enabling the analysis and evaluation of the behavior and performance of crop insurance plans.

In one illustrative form, a system according to the invention includes a comparator to determine and compare the relative historical performance of various crop insurance plans. The comparator utilizes historical information including, for example, actuarial data, historical price data, and historical yield data. In particular, actual production history data may be used. The historical performance comparison can be made under various specified scenarios reflecting different selections made by the user in connection with various crop insurance plan variables, such as price election, coverage level, and protection level.

The comparator is preferably used to compare the relative performance of group-based and individual producer-based crop insurance plans. The comparison will provide an historical account of plan performance taken across any selected range of years. A trend analysis can be undertaken to forecast and/or predict future performance based upon the historical performance.

The system further includes an options analyzer that allows the user to define, for example, hypothetical insurance plan scenarios that are employed to determine the projected performance of various crop insurance plans. The analyzer is particularly useful when making a comparison of projected performance in regards to group-based plans and individual producer-based plans. The analyzer effectively allows the user to implement an unlimited number of “what-if” assumptions, stipulations, suppositions, contingencies, estimates, and/or predictions.

The hypothetical scenarios can be developed using actual data in combination with assumptions. For example, the formulas for crop insurance plans typically require the insured to select among various plan options (e.g., price election, coverage level, and protection level), while also utilizing information that is to be determined in the future subsequent to the commencement date of policy coverage. These future variables, for example, could be harvest price or government yield and price figures.

In one exemplary application, a farmer can use the invention to monitor expected plan performance during the course of the farming season, but before the time arrives for establishing the variable values for purposes of computing final plan coverage. In particular, a farmer can utilize the options analyzer to compute the projected plan performance, based upon certain expectations derived from what currently appears to be the crop business outlook.

For example, the farmer can make certain assumptions or predictions as to what the final value will be for the “open” and as yet undetermined plan variables. For example, the farmer can make a projection as to the final price and yield based upon expected weather patterns and current/expected farming and economic conditions. In this manner, the farmer can monitor plan performance as a running analysis.

Alternatively, the options analyzer can be used to configure a scenario based largely or entirely upon assumptions. The analysis, however, will likely be most meaningful when the assumptions bear some reasonable nexus to what the actual values might be. In one form, the user can continuously generate analysis results by successively testing the system with multiple scenarios that differ from one another by having a different combination of values for the user-related selections and options, while maintaining the other non-user-related variables constant. The user-related selections refer to the variable options that the insured and/or applicant makes when requesting coverage.

In another form, the user can develop scenarios that reflect user-specified values for non-user-related plan variables, such as county-based yield figures and government-established commodity prices that are not typically set by user selection. Additionally, the user can define scenarios that deviate from and/or alter the standard actuarial settings found in the plans, such as the allowed percentage levels of coverage.

In yet another form, the options analyzer can allow a user to essentially develop a new model or scheme for crop insurance plan coverage by accommodating user selection of any of the variable values. Of course, the options analyzer will be equipped to have access to all known crop insurance plans so that the analysis setup will provide the default settings for the various coverage options and specified policy parameters, e.g., allowed percentages of coverage, protection, and price election.

In general, the options analyzer supports a functionality that allows the user to employ any combination of assumptions and/or actual data to set the values for any or all of the variables in a crop insurance plan, whether the variables are user-specifiable (e.g., options for user selection) or non-user-specifiable (e.g., data acquired from extrinsic sources such as government settings and county-related items). Moreover, the user can selectively base the performance analysis completely or partially upon assumptions. Additionally, the user can modify the otherwise fixed actuarial information within a plan.

Alternatively, the options analyzer can be used to calculate the current actual performance of a crop insurance plan based upon actual data assembled for the plan. The results of the analyzer can be used to indicate the expected performance, for example, by programming the analyzer with the required variable values once they have been determined by the government, industry, or county, for example. In this manner, the farmer need not wait for the insurance agent to compute loss and indemnity payments, for example, and then communicate same to the farmer. Moreover, the farmer has an independent means for determining plan performance to verify correct and accurate fulfillment of the plan provisions.

In another form of the options analyzer, a best-case scenario can be computed that allows continuous variation of any selected combination of insurance plan variables until the performance criteria is satisfied.

A business analyzer incorporates the results of the crop insurance plan analysis and evaluation into a financial planning and management program. In this manner, a producer can determine the effect and/or impact of carrying insurance, as measured by a profit and loss assessment, for example. The business analysis can be conducted on a historical basis to determine what would have been the financial impact of carrying any number of selected crop insurance plans under various selected scenarios, e.g., user-specifiable options.

Moreover, the business analysis can be conducted on a forward-looking basis that makes financial projections based upon various assumptions as to farm output, income, revenue, and productivity, for example, as well as various combinations of user-specifiable options and estimates of non-user-specifiable variables.

In another form, an insurance sales agency can use the system to determine their actual and/or hypothetical profit and loss. The system is configured to integrate private hail-related crop insurance plans with the federal-affiliated and/or federal authorized crop insurance plans into a consolidated quotation and management package that enables an analysis and evaluation of all available crop insurance plans. For example, the performance of all insurance companies carrying a GRIP plan can be calculated for a given customer or client base under a specified scenario, whether actual or hypothetical. In this manner, the system enables same-type crop insurance plans carried by different providers to be directly compared. The profit and loss can be measured, for example, by computing values such as revenue streams (e.g., premiums) and payout streams (e.g., indemnity payments).

The system further facilitates a remote access feature that enables individual users to access the insurance analysis and evaluation tools remotely. In this form, the system can be configured at a central site that supports dial-in access from remote locations. For example, a network-based communications architecture can employ a server-based platform that hosts the system software, while a remote user can access the server with a conventional browser and an internet-enabled connection. Alternately, the user can have the system software installed on a home or business computer, while the internet-based server connection can facilitate downloads of software and data updates.

Another feature of the invention is the construction and maintenance of a consolidated database that provides all of the information necessary to run the system. For example, the database includes, without limitation, federal multi-peril crop insurance rates, county crop history data, crop actuarial history, CBOT (Chicago Board of Trade) and KCBOT (Kansas City Board of Trade) commodity pricing history, county land risk ratings, federal land management structures (section-township-range), and end-user added histories for individual crop producers. Essentially, the database includes all of the various types of information needed to fully complete and apply the provisions of crop insurance plans, apart from the user-specified selections and option choices.

The database can be updated at any selected interval (e.g., continuous or periodic) as the information becomes available. In various forms of the invention, the database can be centrally located at a host site and configured for remote access over a suitable network connection. Alternately, the database (in alterable CD-ROM form, for example) can be integrated with the applications software to form a single product. The database can then be updated with network downloads.

According to another form of the invention, a method embodies the features of the invention. Preferably, the method is configured as a computer-implemented process operative within a computer environment.

According to another form of the invention, a computer program product embodies the features of the invention. In particular, the product includes computer-executable program code structures to execute the processing steps to perform the functions of the invention. In one form, a computer-usable medium embodies the program code structures.

One advantage of the present invention is that a user can dynamically instruct the selection and construction of an insurance product comparison that concurrently depicts and demonstrates the relative historical performance of the insurance plans along with the corresponding history of the farmer and the relevant county.

Another advantage of the present invention is that the insurance plan evaluation assesses data from a historical perspective taking into account the various historical conditions, such as commodity prices, federal established prices, and county-related and group-related historical prices and yields.

Another advantage of the invention is that the user can dynamically select and define an unlimited number of “what-if” scenarios that allow the user, for example, to select any combination of plan options (e.g., coverage level, indemnity price election, protection level in terms of dollars per acre) and view the net end result of these selections based on assumptions pertaining to ending price and/or ending yield, while applying the scenarios to both county-based and individual-based plans at the same time to generate relative comparisons.

Another advantage of the invention is the ability to integrate strictly private crop insurance plans (e.g., hail policies) with federal-affiliated and/or federal authorized crop insurance plans to create a universal evaluation and analysis tool.

Another advantage of the invention is that the user can execute the various functionalities of the invention in self-serve mode (i.e., without insurance agent assistance) by a network configuration that remotely connects the user to a computer environment hosting the software-based implementation.

Another advantage of the invention is that the results from the crop insurance evaluation and analysis operations can be incorporated and otherwise integrated into a business planning and financial management package to ascertain the hypothetical, projected, and/or actual effect of carrying any selected crop insurance plans under any specified scenarios, particularly in regards to its impact on the bottom line (e.g., profit and loss).

Another advantage of the invention is that all special products, endorsements, and hail policies can be combined and compared between companies to thereby optimize crop insurance coverage.

Another advantage of the invention is that the invention is dynamically adaptive to the specific needs and requirements of individual users (e.g., farmers and agents) since it enables the user to control and define the scenario environment under which insurance plan performance can be assessed.

Another advantage of the invention is that individual producers and insurance agents can optimize their business performance by allowing direct performance comparisons to be made among various insurance plans under dynamically alterable scenarios, thereby facilitating the selection of best-case operating scenarios meeting desired criteria.

Another advantage of the invention is that the invention can be implemented in a fully automated configuration, such as in a computer environment having a user interactive feature allowing the user to input the user selections and initiate the automated system operations.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram illustration of a system, according to one form of the invention;

FIG. 2 is a block diagram illustration of a system, according to another form of the invention;

FIG. 3 is a block diagram showing in modular form various functional aspects of the invention;

FIG. 4 is a printout of a sample computer-generated screen depicting the operation of an insurance product comparator module, according to a computer-based implementation of the invention;

FIGS. 5A and 5B are sample reports generated from information displayed in the computer-generated screen of FIG. 4;

FIG. 6 is a printout of a sample computer-generated screen depicting the operation of a user profile setup module, according to a computer-based implementation of the invention;

FIG. 7 is a printout of a sample computer-generated screen depicting the operation of a case history archive and compilation module, according to a computer-based implementation of the invention;

FIG. 8 is a printout of a sample computer-generated screen depicting the operation of an insurance product options module, according to a computer-based implementation of the invention;

FIG. 9 is a printout of a sample computer-generated screen depicting the operation of a price setting and maintenance module, according to a computer-based implementation of the invention;

FIG. 10 is a printout of a sample computer-generated screen depicting illustrative statistical information in use with the insurance product comparator, according to a computer-based implementation of the invention;

FIG. 11 is a printout of a sample computer-generated screen depicting the operation of an option analyzer module, according to a computer-based implementation of the invention;

FIG. 12 is a sample report generated from information displayed in the computer-generated screen of FIG. 11;

FIG. 13 is a sample report providing a detailed profile of the performance of an insurance product selected from the array of products displayed in the computer-generated screen of FIG. 11;

FIG. 14 is a sample report depicting the operation and results of a breakeven threshold functionality activated from the option analyzer screen of FIG. 11;

FIG. 15A is a printout of a sample computer-generated screen depicting the operation of a producer expense module associated with the option analyzer module of FIG. 11, according to a computer-based implementation of the invention;

FIG. 15B is a sample report generated from information displayed in the computer-generated screen of FIG. 15A;

FIG. 16A is a printout of a sample computer-generated screen depicting the operation of a producer risk profile module associated with the producer expense module of FIG. 15A and the option analyzer module of FIG. 11, according to a computer-based implementation of the invention;

FIG. 16B is a sample report generated from information displayed in the computer-generated screen of FIG. 16A;

FIG. 17A is a printout of a sample computer-generated screen depicting user selection of spread estimate factors in conjunction with a spread estimate functionality activated from the option analyzer screen of FIG. 11, according to a computer-based implementation of the invention;

FIG. 17B is a sample report generated from information displayed in the computer-generated screen of FIG. 17A;

FIG. 18 is a printout of a sample computer-generated screen depicting the operation of a group risk plan (GRP) analysis module activated from the option analyzer screen of FIG. 11, according to a computer-based implementation of the invention;

FIG. 19 is a printout of a sample computer-generated screen depicting the operation of a user profile setup module for use with the GRP analysis module of FIG. 18, according to a computer-based implementation of the invention;

FIG. 20 is a printout of a sample computer-generated screen depicting the operation of a case history archive and compilation module for use with the GRP analysis module of FIG. 18, according to a computer-based implementation of the invention;

FIG. 21 is a printout of a sample computer-generated screen depicting the operation of a rate/quote calculation module activated from the GRP analysis screen of FIG. 18, according to a computer-based implementation of the invention;

FIG. 22 is a printout of a sample computer-generated screen depicting the operation of a historical payment calculation module activated from the GRP analysis module of FIG. 18, according to a computer-based implementation of the invention;

FIG. 23 is a printout of a sample computer-generated screen depicting the operation of a historical percentage calculation module activated from the GRP analysis module of FIG. 18, according to a computer-based implementation of the invention;

FIG. 24 is a printout of a sample computer-generated screen depicting the operation of a report selector module activated from the GRP analysis module of FIG. 18, according to a computer-based implementation of the invention;

FIG. 25 is a sample report of a yield chart issued from the report selector screen of FIG. 24 and generated with information displayed in the GRP analysis module screen of FIG. 18;

FIG. 26 is a printout of a sample computer-generated screen depicting the operation of a map building module, according to a computer-based implementation of the invention;

FIG. 27 is a system block diagram illustrating a crop insurance risk management service environment, according to another form of the invention; and

FIG. 28 is a flow diagram illustrating an exemplary working session in practice of the invention, for rendering a crop producer financial assessment.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

As used herein, references to “crop insurance plan” should be understood as encompassing, without limitation, any type of insurance policy providing crop and/or agricultural-type coverage.

For example, such plans may include, but are not limited to, a Multi-Peril Crop Insurance (MPCI) policy (e.g., MPCI-APH), Group Risk Plan (GRP) policy, Dollar Plan policy, Group Risk Income Protection (GRIP), Adjusted Gross Revenue (AGR) policy, Crop Revenue Coverage (CRC) policy, Income Protection (IP) policy, Revenue Assurance (RA) policy, private crop hail policy, and catastrophic (CAT) coverage policy.

Moreover, such insurance plans include all crop insurance plans authorized, managed, offered, and otherwise connected with the FCIC and any successor governmental body. However, it should be understood that the invention may be practiced in connection with any crop insurance plan. According to one feature, the invention can be practiced on an integrated basis that allows consideration of private crop hail insurance plans with government-related plans, e.g., private agri-peril plans reinsured by the government (e.g., FCIC). Other private crop insurance plans are also encompassed by the invention.

Moreover, such plans may include hypothetical, experimental, proposed, model, or draft policies, in additional to actual issued and underwritten plans. For example, insurance companies or other entities may develop various models or schemes of crop insurance programs that are not currently or may never be commercially available, for purposes of assessing commercial interest and viability. It should be understood that the practice of the invention can embrace the use of such crop insurance plans.

Moreover, crop insurance plans should be understood as encompassing plans that are authorized by the federal government (e.g., reinsured) and made commercially available. However, insurance plans may also include policies unrelated to any governmental authorization, e.g., state or federal.

As used herein, references to “crop” should be understood as encompassing, without limitation, any insurable agricultural commodity, preferably those that are or may be specified as insurable by the federal government pursuant to the Federal Crop Insurance Act and any successor legislation, the FCIC, the RMA, and/or any other successor federal entity. Generally, the crops discussed herein are those for which any type of crop insurance plan provides coverage, whether actual or hypothetical (e.g., simulation model) and whether having a federal authorization or a non-federal framework.

As used herein, references to the “performance” of crop insurance plans should be understood as encompassing, without limitation, any measure, indicia, and/or representation describing how a crop insurance plan behaves, responds, and/or acts in response to, and in accordance with, specific values and/or selections pertaining to the various variables, settings, factors, and formulations that characterize the policy and its provisions.

For example, crop insurance plan performance may be indicated by values including, but not limited to, trigger level, loss and/or indemnity payment, premium amount, liability amount, loss payment statistics, payout, rate/quotation, subsidy payment statistics, guarantee amount, income, and revenue.

Furthermore, plan performance should be understood as encompassing not only the ultimate end result calculations, computations, and/or formulations, but should be construed as encompassing the intermediate succession of computations and calculations that precede any final determination or calculation. As known, policy formulations involve a succession of calculations and computations to arrive at certain ultimate insurance offering values, e.g., indemnity or loss payment. It should be considered herein that indicia of crop insurance plan performance would include such intermediate calculations and computations along with the end result computations.

For example, typical measures of insurance plan performance include premium amount, liability amount, coverage quotation, indemnification or loss payment (e.g., payout), and deductible. However, other calculations related to the provisions of crop insurance plans are also embraced by the indicia of performance discussed herein.

For example, in certain plans, the insured or applicant makes various selections and option choices including, but not limited to, coverage level, protection level, and indemnity price election. These variable selections are then used to calculate the values of various policy provision factors, according to certain specified policy formulations.

For example, a unit guarantee in an individual producer yield-based plan (e.g., MPCI-APH) would involve a calculation employing a selected percentage of expected yield based upon individual farmer actual production history (APH). This unit guarantee serve as a trigger level for determining when coverage and indemnification occurs. Liability is determined from a calculation employing the indemnity price (e.g., a percentage of the RMA established maximum allowable price) and the unit guarantee. This measures the payout under a zero yield scenario. Indemnity would be determined from a calculation employing the yield shortfall (i.e., differential between actual yield and unit guarantee) and the indemnity price.

The above MPCI-related illustration depicts various illustrative calculated amounts that may be considered indicia of performance of the specific crop insurance plan. For example, such performance measures may include, but are not limited to, the guarantee amount or trigger level, indemnity price, liability amount, premium, and indemnity or loss payment.

Moreover, in a group-based plan (i.e., GRP), for example, the basis for protection is the county expected yield as determined by the RMA in connection with National Agricultural Statistics Services (NASS) county yield data, for example. The coverage level, then, is determined as a percentage of the specified county expected yield to establish the trigger yield for indemnities. The insured selects a protection level, namely, a dollar amount of protection per acre computed as a selected percentage of the maximum dollar amount of protection per acre (which incorporates the RMA-established price and expected county yield). Liability is then determined from the insured acreage and the calculated dollar amount of protection per acre. Indemnity is then determined from a calculation involving the liability amount and a loss percentage calculation involving the trigger yield and payment yield (i.e., actual county yield).

The above GRP-related illustration depicts various illustrative calculated amounts that may be considered indicia of performance of the specified crop insurance plan. For example, such performance measures may include, but are not limited to, coverage level or trigger yield, protection level, liability, loss percentage, and indemnity.

Alternately, the performance of crop insurance plans may be considered to embrace both “on-plan” and “off-plan” performance indications, measures, or values. For example, such on-plan performance measurements would encompass any of the computed values that are specifically determined by the policy plan provisions and related formulas, whether constituting an end result calculation or an intermediate computation. Such on-plan performance indicia may be considered policy plan output values. Furthermore, such off-plan performance measurements would encompass information derived from the on-plan performance indicia.

For example, the policy calculations may be used to formulate performance statistics regarding, inter alia, patterns or trends (e.g., percent change) in loss and indemnity payments over a specified time period; trend analysis regarding correlations between expected and actual yield and between farmer yield and county yield; the number of years in which loss payments were or would have been made (e.g., historical perspective); and a loss payment amount per acre on a historical basis. It should be apparent that plan performance encompasses any type of statistic that is derived or based (at least in part) upon the values and computations generated by the policy provisions.

Although such statistics might not appear as actual performance measurements within the plan document itself, these statistics may prove valuable to a farmer or sales agent in assessing the value of the multitude of crop insurance plans and thereby determining the best plan and the corresponding variable selections. Another performance measure, for example, may involve a business calculation that carries out a profit and loss analysis that reflects the effect and impact of carrying a specified insurance plan under a selected scenario. This financial planning feature enables a farmer, for example, to determine the impact of carrying crop insurance on an historical basis so that a reasonable projection can be made as to the best plan (and scenario) to purchase and select for the upcoming or other future season.

Moreover, when plan performance is determined on a forecast basis using projections of certain plan variables, the results can be incorporated into a financial analysis model that makes projections of certain financial aspects of the producer business. For example, the determination of hypothetical plan performance can be used to develop a profit and loss assessment and/or cashflow evaluation on a predicted basis. Other measurements of financial performance of the farming operation can be derived with the invention. Furthermore, such measurements can be made on an historical basis and/or a projected basis, as chosen by the user.

As used herein, “information” pertaining to crop insurance plans should be construed as encompassing, without limitation, a description and/or representation of the plan itself (e.g., policy provisions, option descriptions, formulations, and calculation procedures concerning, for example, the guarantee or premise of protection, the premium framework, the process by which loss is measured and the indemnity paid, and the liability to the insurer, i.e., the framework for setting rates); values and option selections pertaining to user-specified variables (e.g., coverage level, protection level, and price election) typically made by the plan applicant or insured; and values pertaining to policy factors and parameters not typically determined by user selection but generally considered non-selectable and commonly obtained from extrinsic sources or otherwise to be determined at a later date (e.g., county and government yield and price figures, final harvest price, and farmer actual yield or production to count).

For example, crop insurance plan information includes, but is not limited to, historical, current, and/or updated values regarding commodity pricing, established crop price, established crop yield, coverage level options, rating and/or premium information, price-related and/or yield-related protection guarantees, policy provision calculus and/or formulations, coverage level, price election, protection level, amount of insurance, production to count and/or actual yield, actuarial information, policy provisions, rating information, county land risk ratings, federal land management structures, individual producer actual production history, acreage data, share data, practice data, type data, plant date, crop price data, crop yield data, income data, and revenue data.

Moreover, the plan information may include assumptions and/or actual values for any of the variables, factors, and parameters of the policy provisions.

As used herein, crop insurance plan “variable” should be considered as encompassing, without limitation, any factor, parameter, setting, option, selection, or data item that contributes in any manner to a determination or computation of any indicia of crop insurance plan performance.

For example, plan variables may include, without limitation, applicant-related or insured-related items typically pertaining to option selections made by the insured or applicant (e.g., coverage level, price election, protection level); and non-selectable items relating to factors typically not set by the applicant or insured but determinable at a later date. The plan variables that are to-be-determined (TBD) generally fall within one of two classes, namely, applicant-related and non-applicant-related items. For example, such non-applicant-related TBD items may be determined in accordance with a specified protocol, benchmark, or designated reference source, such as government and county price and yield figures and final harvest price. Such applicant-related TBD items may include ending or actual yield, for example.

Moreover, plan variables may relate to the settings and definitions for policy formulations that generally are fixed within plans. For example, according to one form of the invention, a user may alter otherwise fixed plan settings such as the allowed percentage levels of coverage and protection. However, in one form of the invention, such fixed plan settings will be permanently set as default values, subject to future modification and updating when the settings change (e.g., new policy coverage provisions and issuance of county-related and government-related price and yield figures). Additionally, as changes are made to the framework of plan coverage (e.g., available levels of coverage and protection), these updates and modifications will be incorporated into and otherwise reflected in the plan-related performance calculus.

Additionally, for example, the plan variables may relate to values concerning insurance applicant-related factors, actuarial-related factors, government-related factors, and county-related and/or group-related factors.

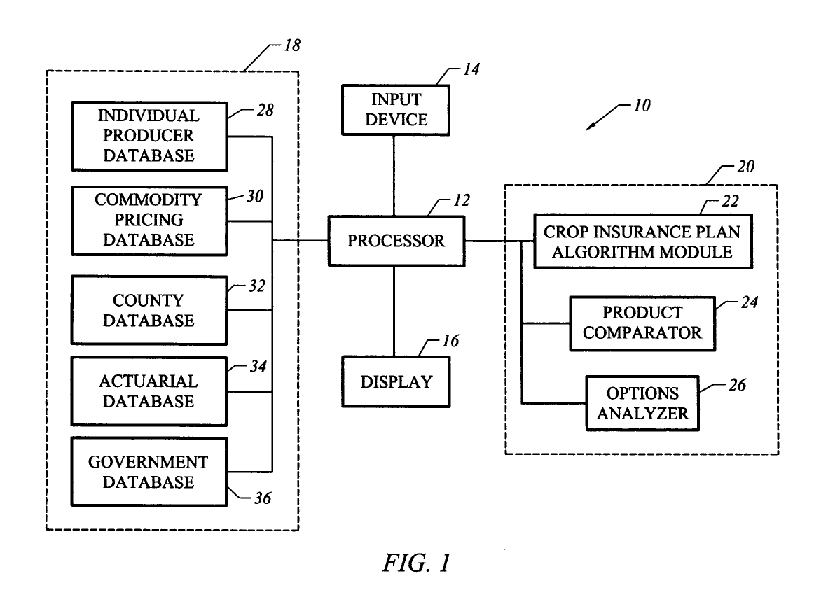

Referring now to the drawings and particularly to FIG. 1, there is shown a block diagram view of a system 10 according to the present invention.

The illustrated system 10 includes a computer environment having at least one processor 12, an input device 14, and a display or viewing device 16. The computer environment is of conventional construction, but may be implemented in any other configuration known to those skilled in the art. For example, the invention can be practiced in accordance with any computer architecture, such as a host-server configuration and a stand-alone computer (e.g., desktop, workstation, or laptop).

In additional forms, for example, the applications software and databases of the invention (discussed further below) may be resident on a single computer platform (e.g., desktop computer). Alternately, in a host-server network configuration, the applications software and databases may be located at a host facility remote from the server site, i.e., the end-user. In an internet application, a conventional browser could be used by an end-user computer to access the software-based embodiment of the invention when resident at the host site.

Furthermore, it is also possible to install the databases at a host site, while the applications software is installed or loaded onto a user machine. The databases can then be accessed in conventional manner by the applications software using a variety of conventional networking and programming techniques known to those skilled in the art.

Referring again to FIG. 1, system 10 further includes a database environment 18 and an applications software environment 20 executable by processor 12.

According to one form of the invention, the illustrated applications software facility or environment 20 implements various features, tasks and operations to enable a user to execute a variety of functions. In one aspect, software facility 20 includes a crop insurance plan algorithm module 22, a product comparator module 24, and an options analyzer module 26. These elements are preferably software-based units constructed using conventional programming techniques known to those skilled in the art, according to the invention.

Briefly, as discussed further, crop insurance plan algorithm module 22 contains all of the formulations, methodologies, calculations, and computational procedures relating to the policy provisions and terms of a plurality of crop insurance plans. In one form, module 22 will contain historical records containing representations of each version of the plan that was in force for each year or other plan period over a certain time frame. For example, module 22 would include the computational scheme regarding the basis for calculating and/or the manner of determining official underwriting company coverage quotations for all specified plans.

Product comparator 24 provides a comparative analysis of the relative historical performances of various selective crop insurance plans according to any number of adjustable scenarios. Options analyzer 26 provides a computation of the hypothetical or actual performance of any number of crop insurance plans in accordance with adjustable scenario definitions that permit assumptions to be entered for any of the plan variable factors. In effect, the options analyzer 26 allows any number of “what-if” scenario determinations to be made regarding plan performance.

Referring now to applications software 20, the illustrated crop insurance plan algorithm module 22 embodies representations of a plurality of crop insurance plans. For example, module 22 will contain all of the actuarial and policy provision information for each plan to facilitate a determination of the various performance measures, computations, and calculations typically associated with applying the terms and conditions of a plan to a particular situation, i.e., a scenario. Module 22 would therefore include, without limitation, all of the formulas and algorithms used to calculate premium, indemnity, coverage, and loss payments. In effect, module 22 includes in representative form all of the materials and documentation that define the contractual relationship between the insurance carrier or provider and the applicant or insured individual.

Briefly, in operation, when a performance measure is requested for a particular plan(s), processor 12 executes the software code embodying algorithm module 22 in conjunction with the relevant input information (e.g., scenario definition and/or user selections) to provide the requested determination. In effect, the scenario values are applied to the selected crop insurance plan to determine how the plan behaves or responds to the particular scenario parameter values.

A scenario, for example, would correspond to the particular environment, situation, or circumstance of the insured (e.g., farmer or producer), whether actual or hypothetical, under which the terms, conditions, and policy provisions of the insurance plan are being applied. For example, scenario values can relate to parameters including, but not limited to, any applicant-specific data or option selections (e.g., protection level, coverage level, price election, farm data); plan-related categories and options (e.g., actuarial data such as the allowable percentage levels of protection and coverage); and other data necessary to implement the policy provisions (e.g., yield-related and price-related data such as the county yield figures and government established price figures).

Referring again to applications software 20, the illustrated product comparator 24 provides a functionality that enables a user to determine the relative historical performances of any number of selective crop insurance plans under any number of selectable scenarios, according to one form thereof. Any type, measure, or indicia of insurance plan performance can be provided. For example, meaningful performance measures would indicate premium costs and loss payment statistics for selected years of interest.

The benefit of product comparator 24 is that a user such as a farmer can determine how a particular plan would have actually performed under various user-selected option scenarios, as applied to actual real-life information in existence at the time(s) that are selected by the user. For example, actual historical yield data (e.g., actual production history and county yield figures) and actual historical price data (e.g., harvest price and FCIC-related price figures) are accessed and employed by product comparator 24 to render the historical performance determination.

As a further benefit, not only can a single plan be evaluated across a variety of user-defined scenarios, but the historical performance of multiple plans across multiple scenarios can be determined. In this manner, the user not only can ascertain the specific scenario under which a single plan achieved the best historical performance, but also determine among all the analyzed plans the combination of specific scenario values and specific plan that achieved the best performance.

Moreover, because the product comparator 24 allows the user to select the plans for comparison, the user can elect to compare plans of the same or different type or employ any other criteria to fashion the comparison. For example, a user may elect only to examine products having the same guarantee-based model, such as yield guarantee, revenue guarantee, and asset guarantee products. Within these categories, a user may further differentiate by selecting group-based, individual producer-based, or mixed plans. Alternately, a user may elect to compare only group-based plans or individual producer-based plans, regardless of the guarantee basis. However, the invention is not limited to any type of comparison, but should be considered as encompassing comparisons where any combination of plans/scenarios can be selected. Moreover, single or multiple plans can be evaluated on the basis of one or more scenario definitions.

The scenario parameters are adjustable and otherwise modifiable by the user. For example, the scenario values or settings for a product comparison would correspond to the available set of user selections made by the insured in regard to the various plan options, such as protection level, coverage level, and price election.

In various forms, the performance measures can be determined in regard to certain selected time frames. For example, the relative historical performances can be determined on a per-year annual basis and/or a cumulative year basis in reference to a selected number of years. For example, a farmer would likely be most interested in determining the specific combination of plan and scenario profile that yields the best historical performance since inception of the farming business or other suitable time period.

Alternately, as one possible predictor of future performance, a user could select a comparison based on a group of immediately prior years, if future conditions were expected to remain the same as the recent past and if certain older time periods were deemed aberrational or isolated. For example, certain years could skew the performance measure if the years were associated with severe weather, economic and price conditions that are not currently present or in existence or which did not persist for too long. The consideration is that the user may select any group of successive or non-successive year(s) for the comparison, if certain years are not of interest or pertain to actual historical data that could unduly skew the results.

As discussed further, product comparator 24 will preferably provide the comparison results in the form of a table, chart or other suitable presentation scheme that facilitates a side-by-side visual comparison of the generated performance measures, both on a per-year basis and a cumulative basis. Other statistics based on these measures are also available.

Because product comparator 24 allows a user to compare the relative historical performances of certain plans operating under the same scenarios, reasoned judgments can be made by a farmer as to which plan/scenario combination might perform best in the future. The user is also free to chose the year(s) upon which to make the comparison. In this manner, each user can customize the historical comparison to their own view of which year(s) are most representative of future performance.

In a computer implementation, the software can conventionally generate a screen layout or other graphic display of the comparison in any suitable format. Moreover, a graphical user interface (GUI) or other suitable interactive mechanism will enable the user to dynamically vary the scenario values and interactively request further processing to generate successive performance comparisons. Also, each iteration can make additions or deletions to the plans being analyzed and adjust the scenarios that govern the performance determinations. In a typical conventional format, users can enter new or updated selections and request further functions by manual keyboard entry, a mouse-type selection device, or function-activating icons. Any user interactive mechanism known to those skilled in the art can be used to facilitate user inputs and selections.

The diverse functionality of product comparator 24 relies upon access to all of the relevant historical data necessary to make the determinations of historical plan performance. Referring again to FIG. 1, the illustrated system 10 includes a database environment 18 that includes, among other information, the historical data used by product comparator 24. The individual data structures of database environment 18 may be provided collectively at an integrated site, available from different sites, or any combination thereof.

For purposes of supporting the functionality of product comparator 24, the illustrated database environment 18 includes all of the historical information needed by comparator 24 to perform the full spectrum of historical performance comparisons, as discussed below.

In one form, database environment 18 includes individual producer database 28 having end-user added histories for individual crop producers. For example, database 28 would contain all of the actual production histories (APH) for individual producers, such as the actual crop yields on a yearly or harvest basis or other common industry basis. In the case of an individual farmer, database 28 would contain the APH data for all of the personal farm property. In the case of an insurance company or sales agent, database 28 would contain the case histories for all of the farmers and producers that hold policies with the company or through the agent. Database 28 could also include data pertaining to historical producer financial records, such as income and asset figures.

Database environment 18 further includes a commodity pricing database 30 that includes the historical commodity prices for all relevant crops for all relevant periods of time. For example, such data would include all of the harvest price data, plant price data, and/or commercial pricing data from relevant industry exchanges, Boards of Trade, and other price-setting groups, such as the Chicago Board of Trade (CBOT) and Kansas City Board of Trade (KCBOT).

Database environment 18 further includes a county database 32 including all of the relevant county-related crop history data for some or all of the appropriate county entities in the United States. This county data, for example, would include the expected and actual county yield and price figures used in group-based plans.

Database environment 18 further includes an actuarial database 34 including all of the relevant crop actuarial histories and actuarial information.

Actuarial data includes, but is not limited to, T-Yields (transitional yields), expected yields, government pricing in the form of initial prices (plant prices) and final prices (harvest prices), high risk ground rating factors, and plan variation price factors such as farm configuration rate factor increases and decreases. For example, a farm configured and specified as optional units incurs a rate factor increase, while a farm configured and specified as an enterprise unit incurs a rate factor decrease.

Actuarial data also includes all rate per hundred of dollars of specified and selected coverage liability for all relevant crops, for all relevant plan types, for all offered countries, in all offered states. All plan type variation and option factors are also embodied in the actuarial data in the form of low/high pricing factors, price volatility factors, risk factors, and various plan variations factors required for the extensive plan calculations and formulas.

Actuarial data also includes all the required rate per hundred data, feature and option factors, etc., for all included company private hail policies and private crop policies that are offered by various companies including, for example, private named peril, multi-peril, group peril, add-ons and endorsements.

Database environment 18 further includes a government database 36 containing all of the relevant historical figures released by the federal government for use in crop insurance plans. For example, in certain plans, the FCIC releases information pertaining to benchmark crop price settings for use in various plans to establish certain trigger levels of payment, coverage, and/or protections. The information, for example, may further relate to rating data, yield data, and actuarial updates.

Furthermore, database environment 18 may include a database of historical plan actuarial data describing the relevant policy provisions that were in force for the years available for comparison using product comparator 24. This facility is needed since the terms and conditions of plans typically change over the years. Accordingly, an accurate determination of historical plan performance requires access to the specific policy provisions that were in place at the time the plan performance is being evaluated. It may also be possible for such historical plan data to be contained within crop insurance plan algorithm module 22.

The database environment 18 also includes data structures pertaining to federal multi-peril crop insurance rates, county land risk ratings, and federal land-management structures (section-township-range). For example, since the crop insurance industry is regulated by the federal government, specifically the FCIC, the appropriate governmental agency (i.e., FCIC or RMA) governs the rate-setting mechanism. Accordingly, a federal rating data structure is provided that contains updatable records of the crop rating structures. Historical rating information is also furnished for purposes of access and use by product comparator 24.

Additionally, the rating structure or scheme is typically associated with the geographical location of the producer farming property and any attendant risk factors that may be assigned to this location. For this purposes, historical information pertaining to the federal land management structures (section-township-range) and county land risk ratings is also furnished by database environment 18.

It should be understood that compilation of the database information and construction of the databases can be accomplished in any suitable manner known to those skilled in the art. Although the use of databases is preferred in the practice of the invention, since it facilitates computer-based implementations and allows electronic maintenance, servicing, and updating of the database records, it should be understood that the historical information required by product comparator 24 or by any other element of the invention may be furnished by any other means. For example, though cumbersome, manual entry of data is possible. Alternately, the information contained and otherwise represented in the databases may be submitted piece-wise from different sources and from different archival mediums.

However, an advantageous database architecture would involve a server-based central repository of data that is maintained in an automated fashion by a conventional system administrator program. Moreover, the administrator would continuously update the individual database records. For example, as APH, county, pricing, yield, actuarial, and other information became available, the database would be updated accordingly. Any conventional means may be used to maintain and service the databases.

In one preferred aspect, the entire system 10 (or at least the relevant portions thereof) are enabled or otherwise configured for network or on-line access, such as over the Internet, World Wide Web, or even proprietary or other third-party networks. For example, if database environment is configured for network access, it then becomes possible to automate the updating of all database records as the new information becomes available or is otherwise released.

Accordingly, although the discussion above regarding database environment 18 involves the compilation and dissemination of historical information for use by product comparator 24, it should be understood that in one form these data structures more broadly encompass both historical and current information (or the most recent). As a result, the practice of the invention can rely upon access to only one database environment to retrieve the relevant data, whether historical or current.

Referring again to applications software 20, in accordance with another aspect of the invention, the illustrated options analyzer 26 allows the user to analyze, evaluate, calculate, compute, and otherwise determine the actual, hypothetical, estimated, predicted, and/or projected performance of any crop insurance plan in response to a scenario definition provided by the user. One notable feature of options analyzer 26 is that it permits the user to adjust the values of certain plan variables and settings that otherwise are reserved for assignment or determination by other than the applicant or insured.

For example, typical plan variables that are available for selection by the insured include a standard set of options, such as coverage level, protection level, and price election. However, in making such selections, the user typically can select from only a certain set of values within each option category. For example, the government will typically set the allowed percentage levels of coverage that are available, which is then reflected in the options choices in the plan. Additionally, there are other variables and plan factors that are fixed in the sense that the user cannot make any selections, even limited ones.

For example, in certain plans, the county and government will release figures to establish settings such as county yield and crop price. From the perspective of the user and the insurance company, even though these settings are strictly considered variables since their value perhaps has yet to be determined at the time the plan comes into force, such settings are viewed as fixed or constant in the sense that neither the user nor the insurance company can control or otherwise determine its value. These non-selectable settings may in nature be relatively fixed or ultimately specifically determinable (such as actual county yields, which are determined in accordance with specific protocols employing actual known data) or comparatively arbitrary, such as trigger price levels set by the government.

In one aspect, options analyzer 26 allows the user to expand the option selections so that the user is not limited by the defined set of standard option selections. For example, instead of being restricted by a certain number of percentage levels of protection, the user can arbitrarily select any other value, even if not allowed by the plan. At a programming level, this feature of adjusting even such “fixed” parameters is readily incorporated into the formulations represented by algorithm module 22 by simply allowing such policy factors to be varied. The dynamic nature of such a plan analysis is evident from the ability of the options analyzer 26 to essentially allow the otherwise predetermined formulations of the plan provisions to be adjusted to fit the choices made by the user.

Additionally, options analyzer 26 also supports a functionality that permits the user to arbitrarily enter selected values for the otherwise fixed or constant settings, namely, the non-selectable policy factors such as county yield and FCIC price. Notably, options analyzer 26 allows the user to choose any value for the factors that are ultimately objectively determinable though currently unspecified (e.g., county actual yield) or the comparatively arbitrary factors, e.g., the settings established by the government. Generally, it should be considered that options analyzer 26 allows the user to select any value for any variable, factor, or setting in a plan.

The flexibility afforded the user to make universal and unrestricted value selections for any of the variables in a crop insurance plan is particularly advantageous to a farmer who utilizes options analyzer 26 to make continuous in-season projections as to how a plan earlier contracted by the farmer will perform. In this situation, the user would enter the same option-type scenario selections as in the actual contract for the crop insurance plan, and then supply the options analyzer 26 with assumptions as to the remaining or outstanding “to-be-determined later” plan factors.

Options analyzer 26 thus provides the user with a valuable tool to make a projection as to how a plan under contract will eventually perform. Although the user is free to make assumptions as to any plan variable or factor, the use of options analyzer 26 as a performance predictor for an actual plan in force will lead the user to make assumptions that are typically correlated to current values of the open plan factors. For example, a farmer can make certain accurate assumptions as to county actual yield based upon current economic conditions and other ascertainable factors that contribute to and otherwise impact the county-wide yield.

In another form, options analyzer 26 can be used to generate “what-if” scenarios that basically allow the user to make assumptions (whether arbitrary or otherwise) as to any or all of the plan variables, factors, and settings. In this sense, the user can virtually create a customized plan. As with product comparator 24, options analyzer 26 can perform its analysis in conjunction with any number of plans under any number of specified scenarios.

For example, a user can decide to request an analysis of a single plan under successively different user-defined scenarios. Alternately, a user can analyze the performance of any number of plans under a common user-specified scenario definition. Furthermore, the performance of multiple plans can be determined and analyzed under successively different user-defined scenarios. In a manner similar to comparator 24, a user can employ any criteria to determine which plans to analyze, e.g., type of guarantee and individual or group basis.

In another form, options analyzer 26 can be used to immediately determine actual plan performance based upon input variable selections that reflect actual values, even for the non-selectable factors. For example, at the end of the season as the values for all outstanding variable factors are established, the user can promptly determine actual plan performance by inputting values pertaining to the released figures. In one form, the user will have the option before analysis begins to instruct options analyzer 26 to always first access database environment 18 to query whether the appropriates databases have been updated with the new or current information, e.g., the government release of price figures. Options analyzer 26 can be programmed to perform this database interrogation automatically.

According to further aspects of the invention, the functionality of options analyzer 26 facilitates the development of a wide range of useful evaluation and analysis tools based upon the results of the analysis. In particular, several useful applications are available with the results obtained from operation of options analyzer 26.

For example, a farmer can use the performance results (whether hypothetical or actual) from options analyzer 26 to determine the impact or effect that carrying the specified insurance coverage would have on the business. For example, the user can make assumptions as to yield and price and supply input data for the other variable factors. The analysis results could then indicate the amount of premiums paid and the amount of indemnification (if any) payable by the plan under the specified scenario definition.

This financial data could then be provided to a business accounting analysis engine or other suitable financial-based model that incorporates the analysis results into a determination of the overall business performance, such as a profit and loss statement. In this manner, the user can determine which plan and scenario combination has the most beneficial effect on the business, as measured by profit and loss, for example. The financial analysis can use any gauge or criteria to establish what constitutes a best financial performance.

For example, options analyzer 26 can be used in conjunction with a financial analyzer to determine best case scenarios, such as optimal profit and/or minimal loss. Alternately, a break-even threshold can be chosen as the desired outcome in order to determine the scenario(s) that will result in such break-even financial performance.

For the purpose of determining the plan-scenario combinations that meet a specified performance criteria (e.g., break-even threshold or a plan-related performance measure), options analyzer 26 can be readily configured through suitable programming to automatically repeat the analysis determinations while continuously adjusting the variable values until the requested criteria is met. This dynamic feature may be configured by the user such that in each test iteration, only a specified set(s) of variables are dynamically adjusted, while the others remain constant at their preselected values.

For example, a break-even yield can be determined while plant price remains constant, or a break-even price can be determined while expected yield is kept constant. Moreover, a break-even yield can be determined while the differential between harvest price and plant price is varied. Alternately, a break-even price can be determined while the differential between actual yield and expected yield (e.g., production shortfall) is varied. These examples are merely illustrative, as any number of permutations and combinations can be used vis-à-vis which variables remain constant and which are varied from one test iteration to the next. In a manner similar to product comparator 24, this financial evaluation feature can be extended to any number of plans under any specified scenario.

Moreover, while the discussion above regarding break-even thresholds and other financial analysis has related to the operation of options analyzer 26, the invention can also allow a similar financial analysis to be conducted based upon the historical performance results provided by product comparator 24. For example, a profit and loss statement can be derived from the historical performance results that likewise incorporates actual historical income and expense information that can be retrieved, for example, from database environment 18. In this case, for example, while options analyzer 26 could furnish profit and loss projections when “what-if” assumption-type scenarios are being tested and applied, a financial analysis that incorporates historical performance data has special interest because it reflects the use of actual realized business data.

Options analyzer 26 and product comparator 24 both have special usefulness for insurance companies and insurance sales agents. A financial analysis for an insurance company would typically correlate profit and loss with the relationship between premiums collected and indemnity payments made. Generally, when not accounting for other business items, a profit occurs when premiums exceed loss payments, while a loss results when indemnities exceed the collected premiums. Accordingly, in terms of measuring both historical and projected profit and loss, the product comparator 24 and options analyzer 26 can be operated as above and the results similarly incorporated into an accounting analysis, and further in accordance with specified benchmark accounting criteria (e.g., break-even points).

Insurance sales agents typically contract with multiple insurance companies, sometimes even to sell comparable or same-type plans. Accordingly, the agent can deploy a conventional accounting package tailored to the sales agent business model and exercise both product comparator 24 and options analyzer 26 in the manner described above to provide financial performance data (e.g., profit and loss figures) on both a historical and future projection basis and in accordance with specified benchmark accounting criteria (e.g., break-even points).

Another feature of the invention is that all of the operations and functionalities discussed herein are not limited in any fashion to a particular type of crop insurance plan. For example, while the federal government retains regulatory authority over and acts as a reinsurer to various multi-peril crop insurance plan schemes, private hail insurance is available without such government oversight.

One advantage of the invention is that it can be practiced equally with such private hail insurance plans concurrently with the other plans mentioned herein. Accordingly, at every level of functionality in the invention, hail insurance plans are available as one of the plans for processing, evaluation, analysis, and comparison. In this manner, the invention offers a universal application that assimilates and otherwise integrates all crop insurance plans into its working environment.

A further feature of the invention is that new and updated crop insurance plans can easily be integrated into the system. For example, as new plans become available or certain policy provisions are changed or updated, the relevant information for the new plans and the revisions can be incorporated into the system using any conventional technique. In particular, algorithm module 22 can be suitably updated and revised.

It should be understood that product comparator 24 and options analyzer 26 interact with algorithm module 22 in a manner readily apparent to one skilled in the art. For example, as historical data is retrieved by product comparator 24, the comparison operation applies the historical data and other relevant input information to the appropriate plan-specific algorithms in module 22 to generate the performance results upon which the comparison is derived. Similarly, options analyzer 26 applies the variable selections and values supplied by the user to the appropriate plan-specific algorithms in module 22 to generate the corresponding performance results that may then serve as the basis for further analysis. In either operating mode, it may be considered that product comparator 24 and options analyzer 26 formulate a scenario definition that is applied to algorithm module 22. These functional units may be implemented in various conventional ways known to those skilled in the art, such as discrete software elements or a fully integrated program code package. The invention should not be limited by the manner of such implementation.

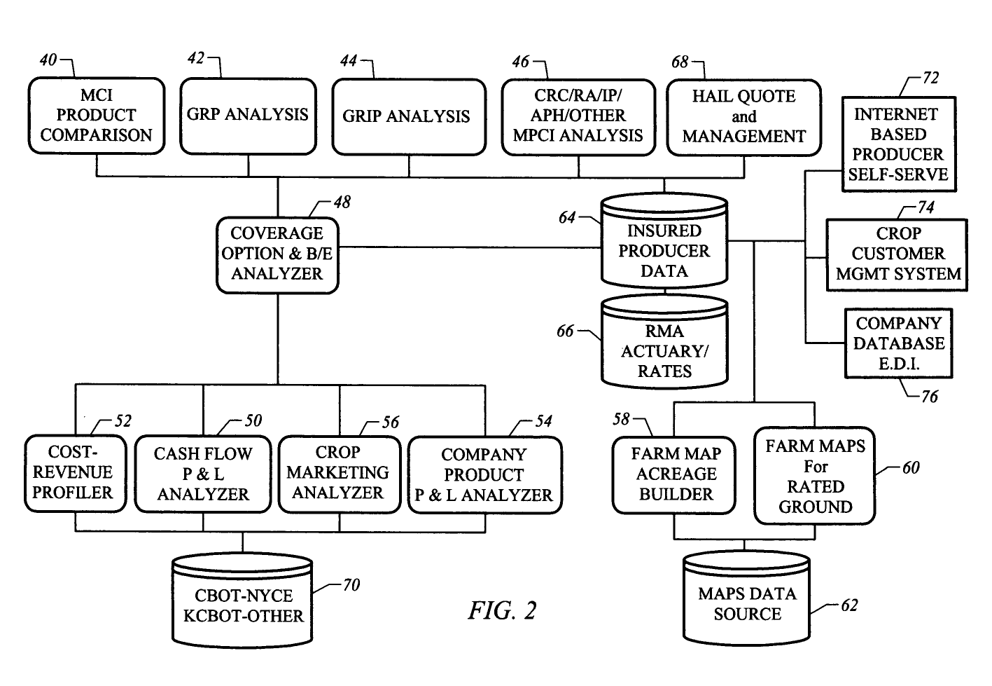

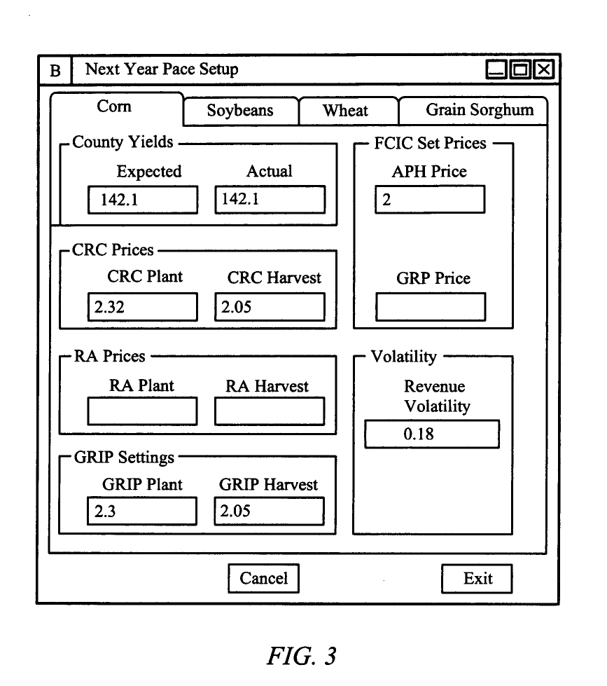

Turning now to one example of the operation of the invention, reference is first made to FIG. 2, which is a functional block diagram illustration of one form of the system depicted in FIG. 1, showing the logic relationship between various functional elements of the invention. Additionally, reference is also made to FIG. 3, which shows in modular form one typical relationship between the suite of analysis and evaluation tools and the suite of available applications employing the analysis and evaluation results, according to the invention.

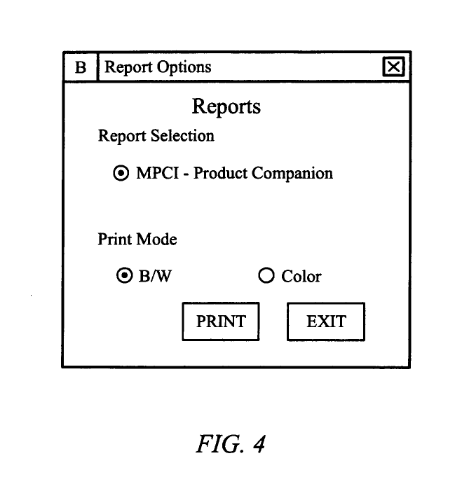

An explanation of FIGS. 2 and 3 is accompanied by contemporaneous reference to FIGS. 4-26, which show a series of illustrative computer-generated screen layouts and printed reports depicting execution and implementation of the invention under an exemplary set of input data and user selections, according to a software-based embodiment of the invention. The screens were generated, for example, as a user executes the applications software and progresses through various ones of its functions, namely, a multi-product historical comparison and an insurance plan options analysis.

The format and manner of presentation depicted in the computer-generated screens of FIGS. 4-26 is shown for illustrative purposes only and is merely representative, as other manner of computer-based delivery of the functional features of the invention are possible within the scope of the invention. It is well within the purview of one skilled in the art to alter or build other screen layouts and schema to equally convey the indicated performance and analysis results, for example.

In brief overview, reference is first made to FIG. 3 to shown the different layers of functionality of one form of the invention. As shown, there is a suite of analysis modules 300 and a suite of application modules 302. The illustrated analysis module suite 300 includes programs to execute an historical product comparison 304, a crop insurance coverage options analysis 306, and a commodity marketing options analysis 308, which logically correspond to elements 40, 48, and 56 in FIG. 2, respectively. Suite 300 also includes a farm mapping function 320, which logically corresponds to element 58 (FIG. 2).

The illustrated application module suite 302 includes programs to execute a financial/business analysis 310 that further includes a cashflow calculator 312, a profit-loss calculator 314, a break even calculator 316, and a profitability measurement 318. These units are functionally represented by elements 48, 50, and 52 in FIG. 2.

Generally, the analysis results from analysis suite 300 are used by application suite 302 to provide a variety of customized end-user information relating to the financial assessment of the farming operation, according to one form of the invention. Of course, the analysis results from the historical product comparison and the options analysis are themselves beneficial in terms of comparatively evaluating the performance and behavior of different plans under different scenarios. However, the analysis results have particular significance when incorporated into actual working models for evaluating the financial stability of businesses, e.g., a profit-and-loss assessment.

Referring now to FIG. 2, a user may launch an MPCI analyzer software program to request a product comparator function, namely, the execution of a Multi-Peril Crop Insurance (MPCI) product comparison module 40.

FIG. 4 shows a computer-generated “Product Comparison” screen describing the results of the comparison operation and various other measures of performance comparison, launched by invocation of the product comparison module 40 (FIG. 2). The historical data that served as the basis for the comparison is also generated. For example, the data in screen area 81 (price grid) shows the relevant historical commodity prices associated with the pertinent crop insurance plans for each of the years of the historical comparison. This historical crops pricing data, for example, could be obtained from database environment 18 (FIG. 1). As shown, the screen header identifies the producer for whom the comparison is being performed.

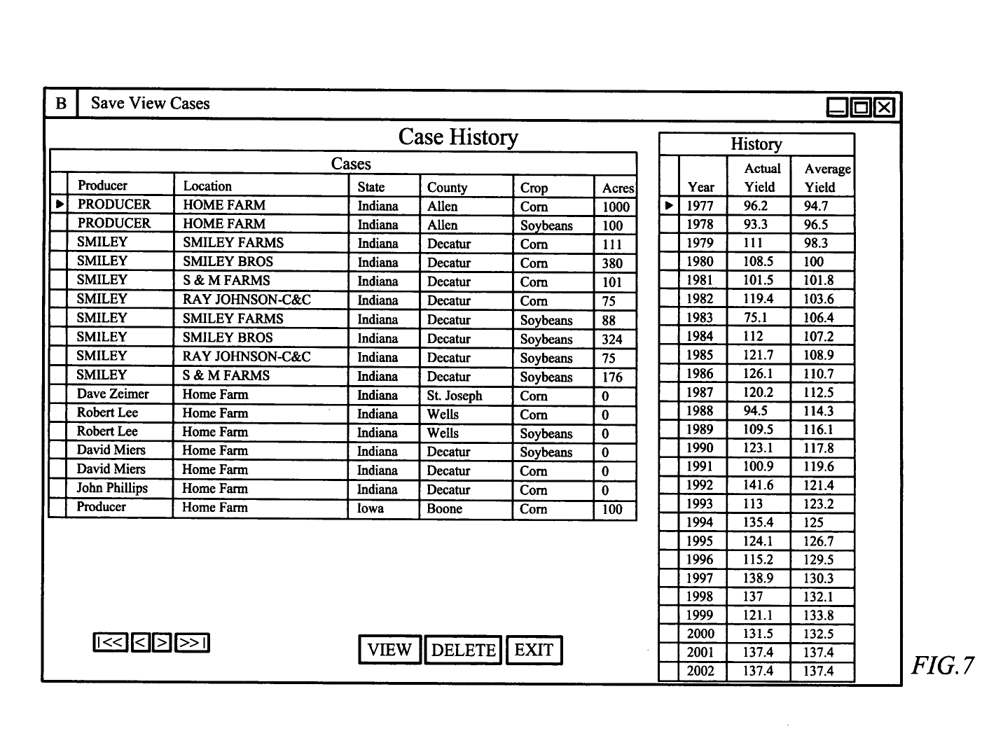

Referring still to FIG. 4, the screen area 82 (year grid) contains and/or reproduces the yield-related case history data furnished in the screen of FIG. 7 (discussed below). Screen area 83 (loss payment grid) provides the results of the historical comparison determination. In one exemplary form, the performance measure is expressed as loss payments (i.e., indemnity) according to a variably selected 100% dollar coverage selection, although other percentages could be selected. As shown, the data is organized in a tabular format so that each row corresponds to a specific year, making it easy to view the historical performance results and correlate them to the underlying data from which the results were derived.

The performance results in loss payment grid 83 are subdivided as shown to display the results for a specified set of plans (e.g., CRC, APH-MPCI, RA, and GRIP) each operating under various selected scenarios. For example, the historical performance of each indicated plan is computed under different scenarios corresponding to different percentage levels of protection. These scenario definitions are shown by the table row indicated generally at 84.

Accordingly, the comparison results depict the actual historical performance (i.e., loss payments over 1979 to 2003) of a specified set of crop insurance plans under a specified set of user-defined scenarios, determined on the basis of the indicated actual historical crop yield data and pricing data. The tabular format makes it easy to look at a certain year (i.e., a row record) and directly compare the performance of various plans on the basis of the same underlying information (i.e., yield and price data) and which operate under similar or identical scenarios. Different year ranges may be selected by the user in requesting an historical comparison. For example, a right-click inside the year grid 83 may generate an input field prompting the user to enter the number of years before continuing with the comparison. Other programming techniques may be used to facilitate selection of such comparison criteria.

The screen of FIG. 4 also preferably includes a summary and analysis section 85 that analyzes the historical performance results and furnishes various statistical measures of relative crop insurance plan performance. For example, while the historical performance chart 83 provides a snap-shot view of the annual performance of the various plans under multiple scenarios, analysis section 85 generates a cumulative statistical measure of performance that takes into account and is otherwise derived from the entire 25-year historical performance results. For example, one statistical indicia of performance may be cumulative loss payments and premium costs (i.e., “EST. 25 YR LOSS PAYMENTS” and “EST. 25 YR PREMIUM COST”). These statistical measures should be considered as simply illustrative, as other indicia of performance are possible within the scope of the invention.

The Product Comparison screen of FIG. 4 also provides a set of product tabs 86 that enable a user to switch among a variety of listed crops for purposes of launching other crop-specific historical plan comparisons. As shown, the illustrated comparison relates to corn. The screen also includes a set of activatable function buttons 91 (Reload), 92 (Analyzer), 93 (Save/View), and 94 (Print).

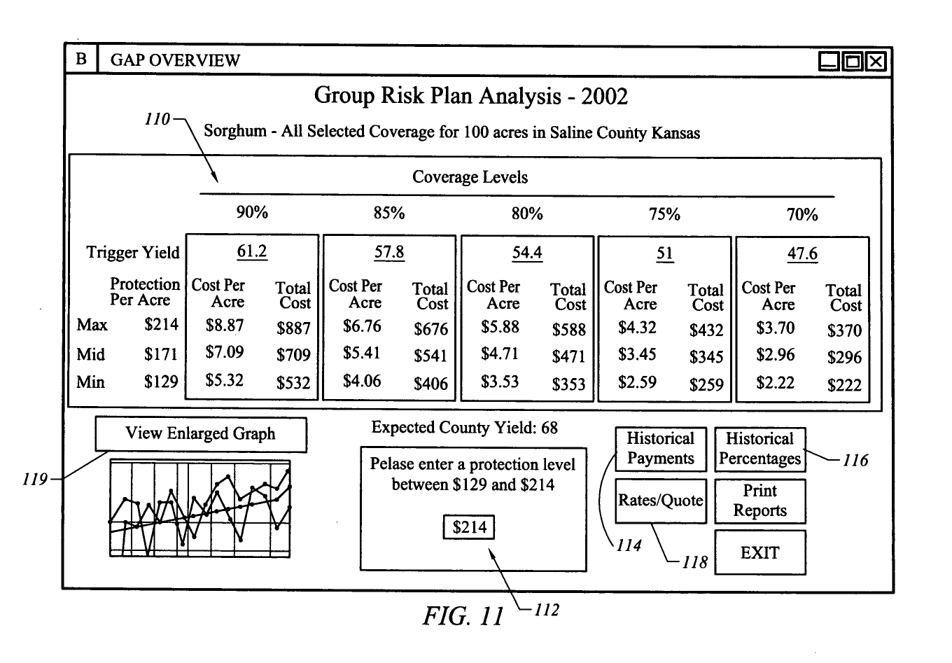

The Reload button 91 enables a user to rebuild a screen and generate a new updated comparison using newly loaded county information, for example. The Analyzer button 92 enables a user to launch the option analyzer module 48 (FIG. 2) having a corresponding computer-generated “Option Analyzer” screen (FIG. 11), discussed below. The Save/View button 93 enables a user to launch a “Save-View Cases” screen (FIG. 7).

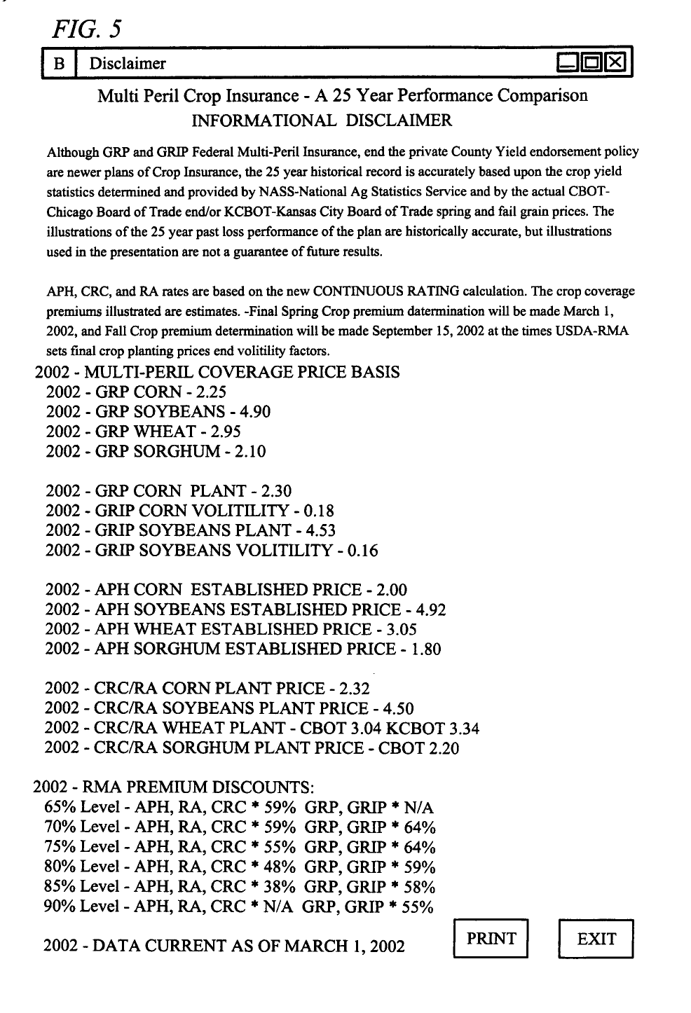

The Print button 94 enables a user to create a product comparison report based on the comparison data on display in the associated screen. For example, FIGS. 5A and 5B are illustrative performance comparison reports generated from information displayed in a corresponding Product Comparison screen in connection with a first set of plans (i.e., CRC and RA) and a second set of plans (i.e., GRIP and GRP), respectively.

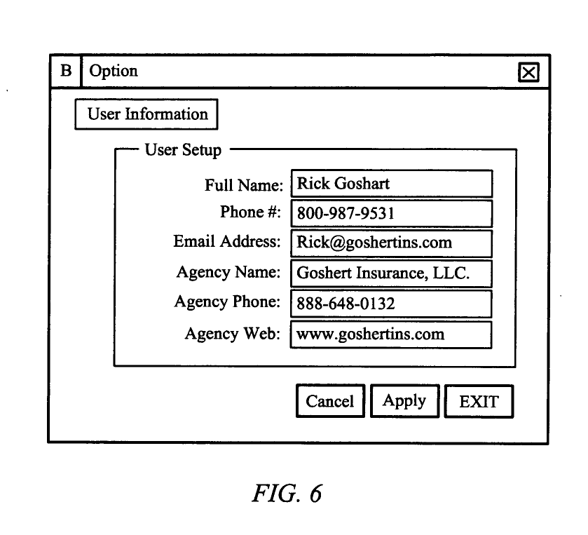

As shown, the screen of FIG. 4 also includes a menu and icon bar with various options, namely, “File”, “Tools”, “Screen”, “Analyzer”, “Price Maintenance”, “Disclaimer”, and “Help”, which are discussed further in connection with the computer-generated screens of FIGS. 6-11.

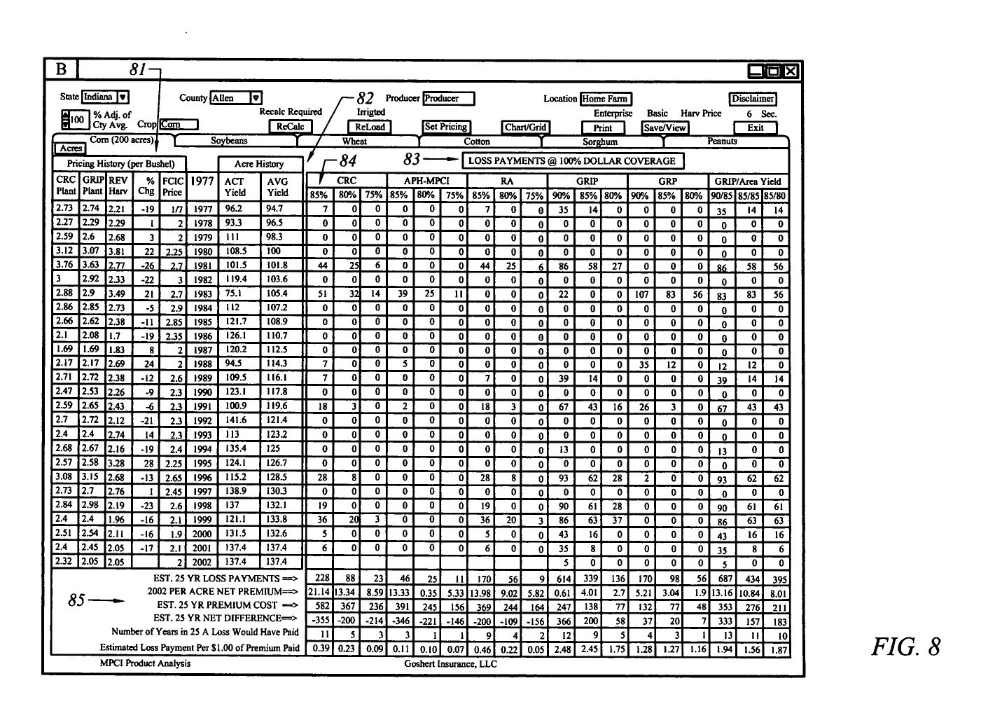

Briefly, the File menu enables a user to save a current case or view a saved case in connection with a Save-View Cases screen (FIG. 7). The Tools menu enables a user to launch the Agent information screen (FIG. 6) or Product Options screen (FIG. 8). The Screen menu enables a user to launch a Product Comparison report generator. Additionally, from the Screen menu, a user can initiate a reload function that reloads the product comparator module with new county yield data, and can further initiate a recalculate function that recalculates the product comparison data matrix after such yield changes are made.

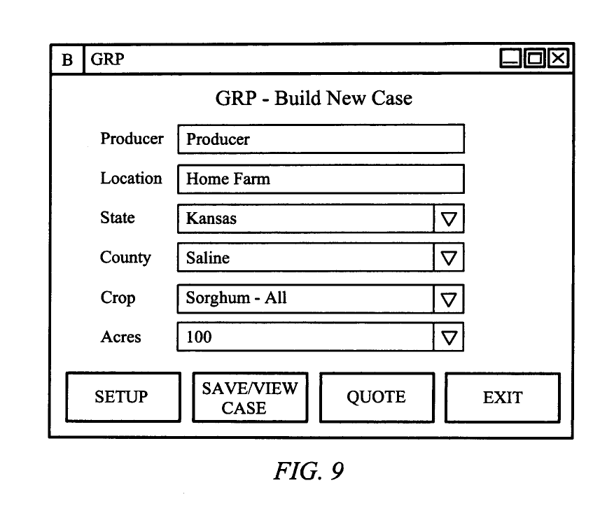

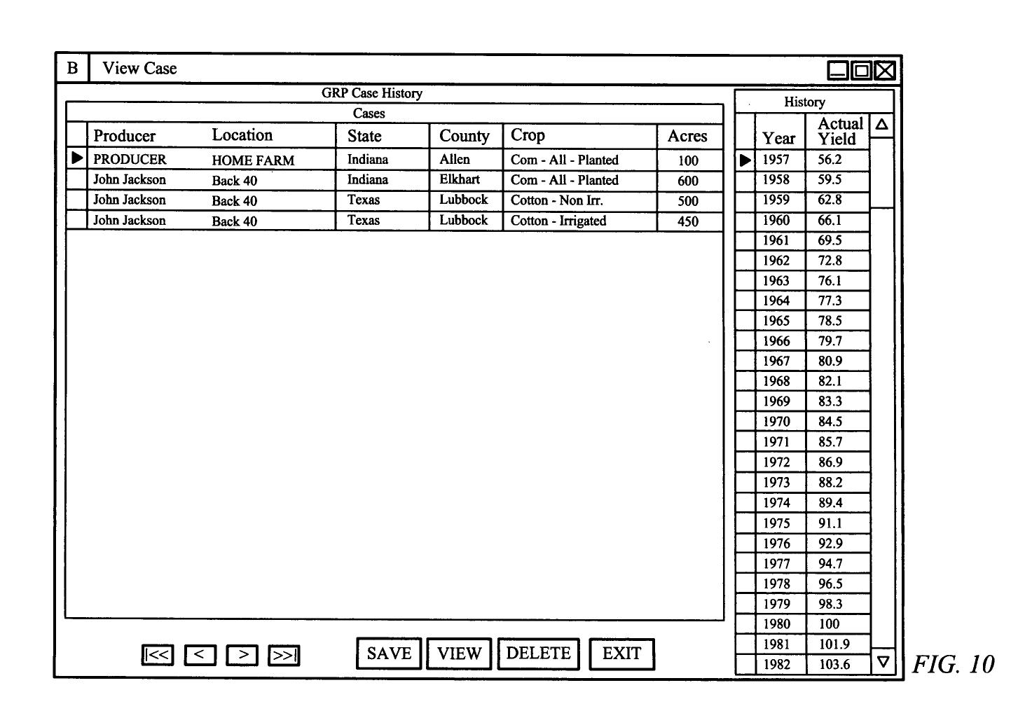

The Analyzer icon enables a user to launch the Option Analyzer screen (FIG. 11). The Pricing Maintenance icon enables a user to launch a pricing maintenance function (“Next Year Price Setup” screen) (FIG. 9). The Disclaimer icon enables a user to view a software disclaimer screen (FIG. 10), while the Help icon allows a user to view and access a help utility for the overall software package.

Referring now to FIG. 6, there is shown a computer-generated “Agent” screen for use in soliciting information about the user through a user profile setup. This screen is accessible through the Tools menu of the Product Comparison screen (FIG. 4).

In particular, contact and other useful information are entered by the user into the appropriate fields displayed on the screen. The user identification may be used to retrieve case histories associated with the specified user. For example, in the case of a sales agent, the case history information would provide records relating to the agent clients, namely, the individual producers for which the agent has written insurance plan contracts. This case information could be maintained on a database or other suitable means.

Referring now to FIG. 7, there is shown a computer-generated “Save-View Cases” screen for use in saving a case entered on the Product Comparison screen (FIG. 4). Any previously saved case may be viewed by selecting the producer of interest. An Update History button appears after yields data has been modified. For example, after updates have been made to the actual or average yield, selection of the Update History button will apply the updates and make such data available for use in a next historical product comparison.

Regarding FIG. 7, it is possible from this screen for the user to select the particular farmer or producer for whom a historical product comparison will be determined. For example, the highlighted producer is selected as shown, which prompts the display of actual producer history data corresponding to the selected producer for the relevant years of interest, e.g., 1977-2002. The current year data, for example, can be selected or simply assigned the values from the prior year. The actual yield data is generated side-by-side with county yield data for comparison purposes. The displayed record for the indicated producer also details other relevant information for use in the performance comparison, such as acreage and locations. The case history data could be available, for example, from database environment 18 (FIG. 1).

Referring now to FIG. 8, there is shown a computer-generated “Product Options” screen for use in allowing the user/agent to view the products (insurance plans) and prices to be compared. In particular, the tabs may be used to select a product and further select the plan options that will serve as the criteria or basis for computing historical plan performance and comparing the results across various plans.

As shown for the selected CRC plan, the user may make selections pertaining to available percentages and price options. As shown in the Product Comparison screen (FIG. 4), these option selections are reflected in the comparison result categories for the CRC plan, namely, in the price grid 81 (“CRC Plant”, “CRC Harv”, and “CRC % Chg”) and loss payment grid 83 (85%, 80% and 75% level results). In particular, activation of the “Apply” button will update the selections made by the user to newly define the parameters for computing plan performance in the Product Comparison screen. This screen is accessible through the Product Comparison screen.

Referring now to FIG. 9, there is shown a computer-generated “Next Year Price Setup” screen for use in setting the prices for each indicated crop. As shown, the price profile may be modified for a variety of crops. In one form of the invention, the values for the fields in the “FCIC Set Prices” and “County Yields” boxes are not user-selectable, but are standard or industry values that are obtained from the appropriate source, e.g., the relevant government or county authority. In one configuration, these fixed values may be provided from the relevant data records of database environment 18 (FIG. 1). This pricing maintenance screen is accessible through the Product Comparison screen.

In another form, it is possible to program the screen of FIG. 9 such that any variable may be modified. For example, values for all of the indicated fields may be supplied by the user, even for parameters typically determined and released by the county, government and Boards of Trade, e.g., price and yield data. The values from this screen facilitate completion and extension of the historical product comparison through the current year (e.g., the year following the last historical year), since the current season may not have been completed and the relevant data realized and otherwise finalized.

In one form of the invention, the crop coverage analyzer generates pricing and comparisons of various crop insurance scenarios and their 25 year performance comparison. Historical payments, for example, utilize standard loss calculations and historical prices based on FCIC, CBOT, and KCBOT information and records. Accordingly, with reference to the computer-generated “Disclaimer” screen of FIG. 10, there is shown an informational screen display describing the price basis for determining MPCI coverage for a variety of MPCI insurance plans in relation to the indicated crops. In the illustrated example, these price values will be used to extend the historical performance comparison to the current year. Moreover, premium information is furnished as generated by the appropriate agency, namely, the federal Risk Management Agency. This screen is accessible from the Product Comparison screen.

Referring now to FIG. 11, there is shown a computer-generated “Option Analyzer” screen that enables a user to define a scenario for determining insurance plan performance or behavior on a projected or assumption-type basis by making various plan option selections, such as plan variable choices pertaining to yields, plant and harvest price, coverage level, and percent of dollar coverage. After a plan scenario or profile is changed, the results of the plan performance analysis are recalculated. This screen is accessible from the Product Comparison screen.

In particular, referring to FIG. 2, the user may launch an options analyzer software program to request a product performance analysis 48 based on various option selections. For example, in the screen of FIG. 11 generated by such analysis module 48, analysis results are displayed involving a set of specified individual-type plans (shown generally in screen area 162) and a set of specified group-based plans (shown generally in screen area 164).

Various option and variable selections are possible within this screen to test the performance of the indicated plans. For example, screen area 168 allows the user to enter values typically reserved for the FCIC, namely, crop prices. These setting values may be actual (as retrieved from database environment 18 of FIG. 1) or hypothetical, i.e., an assumption. Typically, however, the screen will be programmed so that the “FCIC Set Values” fields are fixed settings not subject to user modification. Moreover, the fields shown generally at screen area 166 allow the user to enter actual or hypothetical values for the indicated crop prices, e.g., “Plant $” and “Harvest $” for both categories of risk plans.

Referring to screen area 162, it is seen that other plan options and factors may be variably selected, such as percentage levels of coverage and dollar protection (i.e., the fields indicated generally at screen area 163) and the average/actual yield values (i.e., the fields indicated generally at screen area 165). Likewise, in the county plan screen area 164, the user can variably select percentage values of coverage and dollar protection (the fields in screen area 167) and the expected/actual county yield values (screen area 169).

Again, some or all of the data field values may be actual or hypothetical. It is seen that among the data fields present in the screen of FIG. 11, the values for any of the variables, settings and factors of the specified crop insurance plans can be set to any amount, even for those variables typically unrelated to the standard set of user options (price election, percentage levels of protection and coverage), such as FCIC price/yield and county data.

The FIG. 11 screen depicts generally at screen area 171 the various indicia of performance based upon the indicated parameter value selections. For example, trigger level, dollar coverage, loss payment, and premium per acre are but a few of the vast number of performance measures that can be calculated based upon the input variable data.

Various other functions may be accessed from the Option Analyzer screen of FIG. 11. For example, the illustrated screen also depicts icons or tabs 170 (“VIEW DETAIL”), 172 (“BREAK EVEN”), 174 (“PRODUCER EXPENSE”), 176 (“RISK PROFILE”), and 178 (“SPREAD ESTIMATE”) that allow the user to select various other operations based upon the options analyzer results.

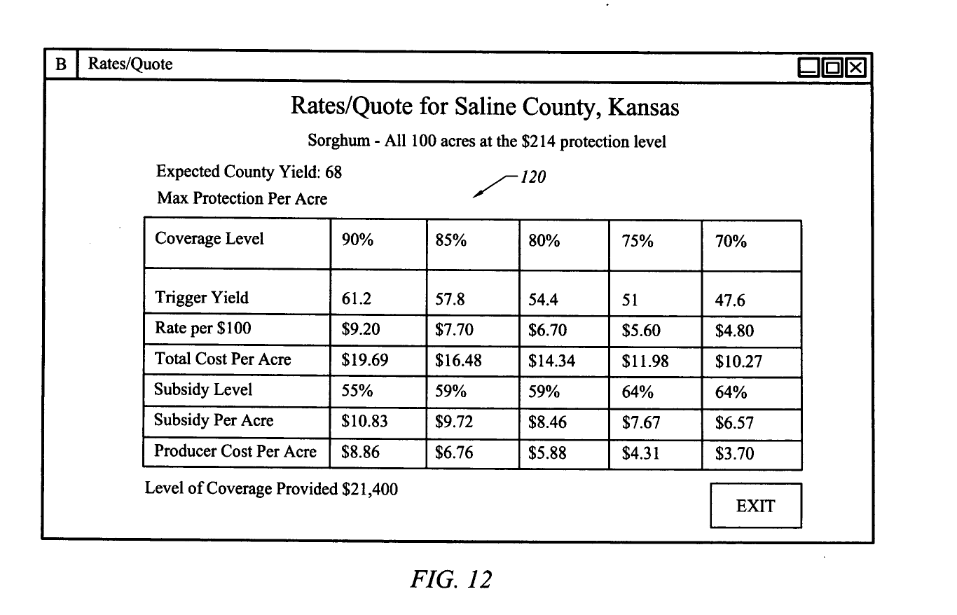

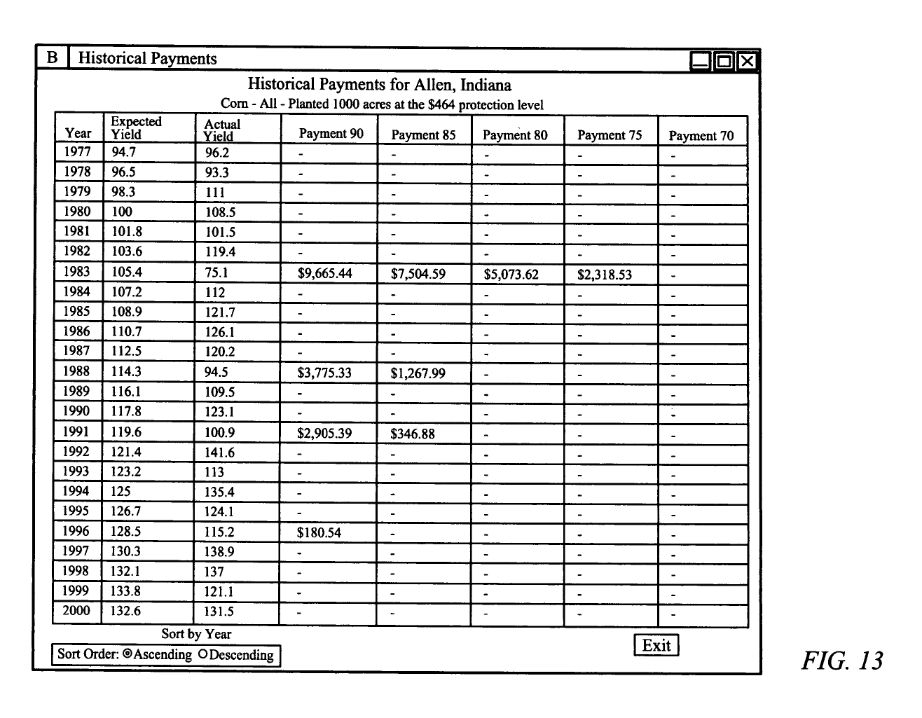

Referring to FIGS. 12 and 13, there are shown reports generated by activation of the Print tab 173 and View Detail tab 170 in the Option Analyzer screen of FIG. 11 that provide a multi-plan and single-plan analysis detail, respectively. In particular, the report of FIG. 12 displays the comparative analysis results produced in the screen of FIG. 11, while the report of FIG. 13 provides specific detail of the CRC plan analysis results, as selected by the user from the FIG. 11 screen. FIG. 13 also shows in further detail additional statistics based upon the analysis for the CRC plan. Similar analysis details are likewise available for the other plans.

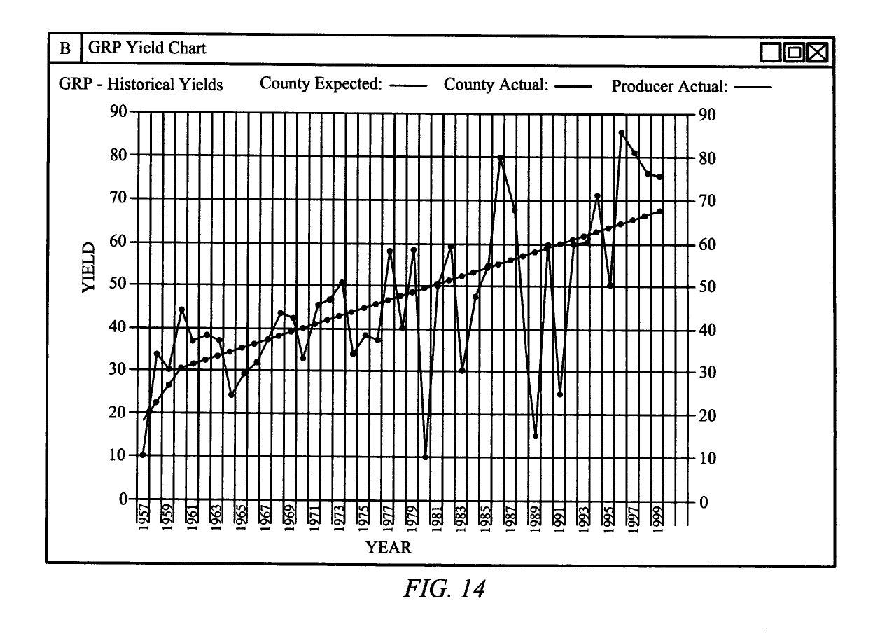

FIG. 14 illustrates a Breakeven Threshold report generated by selecting icon 172. This report shows the break-even threshold points (price and/or yield) under different scenario definitions. For example, a break-even yield can be determined while plant price remains constant, or a break-even price can be determined while expected yield is kept constant. Moreover, a break-even yield can be determined while the differential between harvest price and plant price is varied. Alternately, a break-even price can be determined while the differential between actual yield and expected yield (e.g., production shortfall) is varied. This functionality is associated with module 48 in FIG. 2. The invention, therefore, encompasses the algorithms and computational tools needed to perform such break-even threshold analysis. It should also be apparent that a computer-generated screen may be produced that displays the information conveyed by the Breakeven Threshold report of FIG. 14.

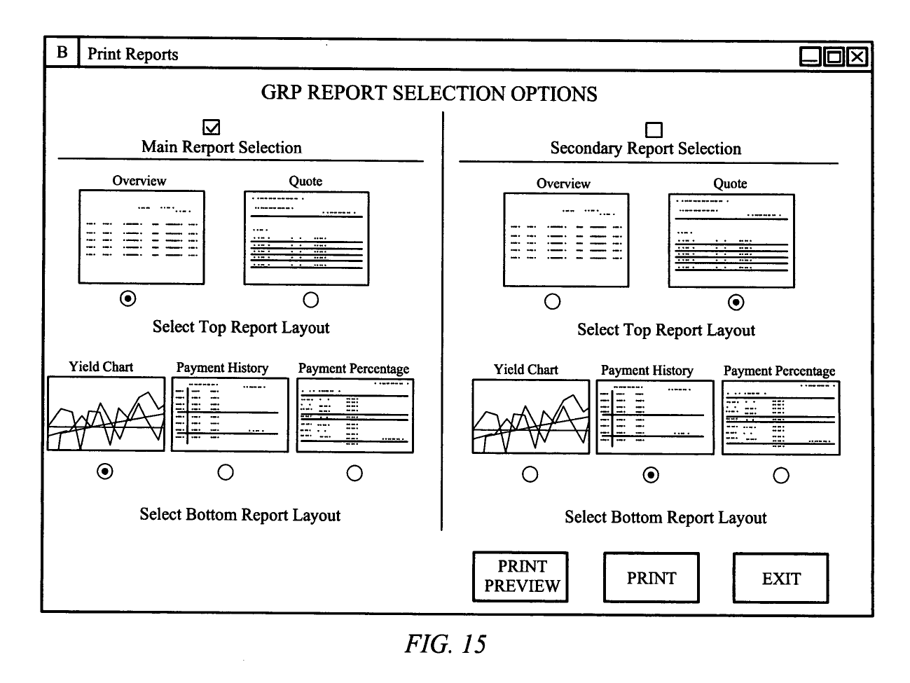

FIG. 15A depicts a computer-generated “Producer Expense” screen launched by selecting icon 174, corresponding to function 50 in FIG. 2. According to one aspect of the invention, the analysis results, and in particular the loss payments and premium data, can be incorporated into the accounting scheme of the producer business to gauge the impact of carrying insurance, such as on a profit and loss basis. Expense data may be entered by the user into the appropriate fields as either cost per acre or as a total coast for all acres. Both data columns, however, are populated with corresponding values. Alternately, the producer expense data can be selectively or automatically loaded into the relevant data fields from a database.

FIG. 15B illustrates a report generated from the Producer Expense screen displayed in FIG. 15A, such as by activation of Print tab 193.

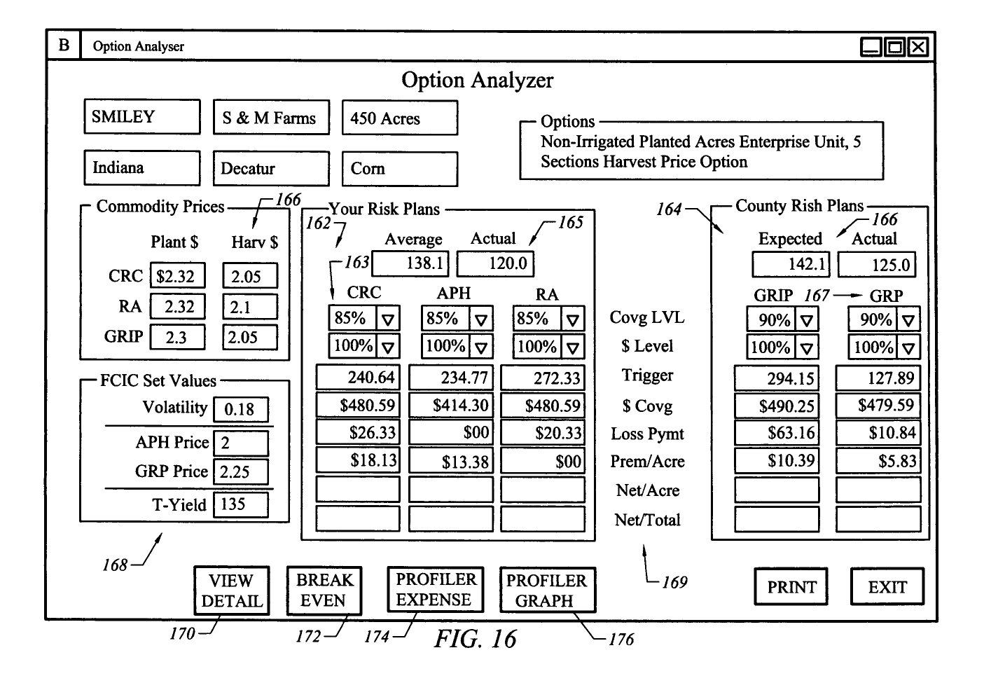

FIG. 16A depicts a computer-generated “Producer Risk Profile” screen launched either by selecting the “View Profile” icon 192 in FIG. 15A or the “Risk Profile” icon 176 in FIG. 11, corresponding to functions 50 and/or 52 in FIG. 2. As shown in the chart and graphically, FIG. 16A allows a user to determine an overall profit and loss profile according to various combinations of revenue per acre, price, yield, and crop insurance cost, as furnished and derived from the option analyzer results.

FIG. 16B illustrates a report generated from the Producer Risk Profile screen displayed in FIG. 16A.

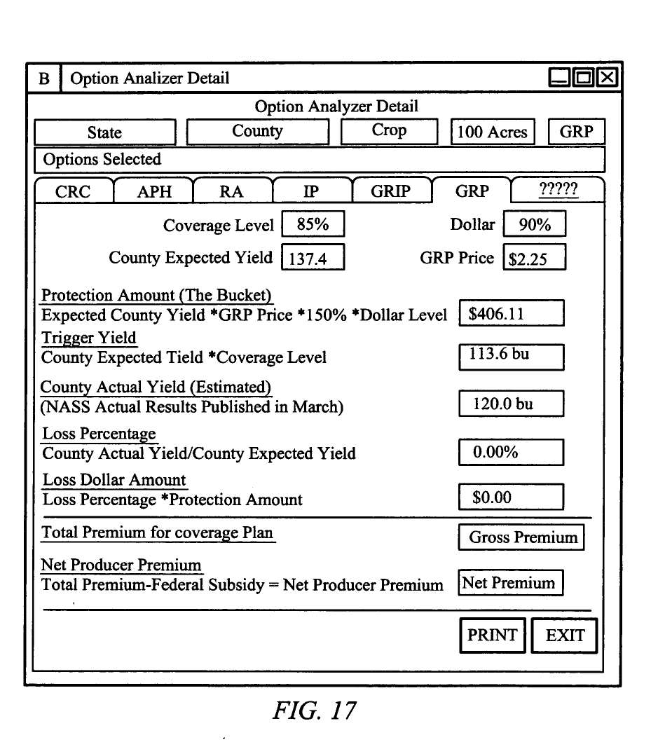

FIG. 17A shows a computer-generated “Spread Estimate” screen representative of a function that sets the price and yield factors. This screen is activatable from icon 178 in the Option Analyzer screen of FIG. 11. As shown, the user can select the price factor and yield factor values. In particular, the spread estimate function takes the user's selected ‘start point’ for each type of coverage and assumes that as the ‘center point’. Then a chart is created, varying both ending price and yield, by user selectable increments, both upwards and downwards. The result is a ‘spread’ of all the possible intersects within the specified range, demonstrating the ending benefit to the producer of each type of selected policy. For example, the three-dimensional Revenue-Price-Yield chart shown in the Producer Risk Profile screen of FIG. 16A is one such chart that employs this spread estimation.

FIG. 17B illustrates a report generated from the Spread Estimate screen displayed in FIG. 17A.

Referring again to FIG. 16A, the data matrix indicated graphically and in table format generally correlates various input price-yield combinations with resulting corresponding revenue figures. In general, a certain commodity/market price-yield combination will generate a certain transactional cashflow or income for a producer. The overall profit-and-loss will then be computed by deducting from the crop income the total amount of producer expenses, which will reflect insurance costs such as premium amounts per acre. The cashflow for the producer will also be affected by any loss payments received due to any applicable insurance coverage, which in turn will be a function of the price-yield combination values relative to the trigger points specified in the insurance plan, i.e., whether the trigger levels were reached to cause an indemnification event.

When the Risk Profile function is activated from the Option Analyzer screen (FIG. 11), the functionality of modules 50 and/or 52 (FIG. 2) is invoked to generate plural income data values each corresponding to a particular price-yield combination. Further regarding the income ledger, the producer will receive income in the form of loss payments depending upon the applicability of the insurance coverage. In particular, the functionality underlying the Option Analyzer screen of FIG. 11 will facilitate a determination of any indemnification for each price-yield combination, e.g., the values in the “Loss Pymt” fields.

On the expense or outlay side of the business ledger, the offsets to income will comprise, for example, the operating business expenses and the crop-related insurance costs, i.e., the premium amounts paid out. In the invention, such business expenses are furnished in connection with the functionality of the Producer Expense screen (FIG. 15A). Moreover, the functionality underlying the Option Analyzer screen of FIG. 11 will facilitate a determination of the premium costs for each price-yield scenario, e.g., the values in the “Prem/Acre” fields.

As a further enhancement to the profit-and-loss model, the invention can also incorporate the income and expense items pertaining to commodity contract transactions undertaken by the producer, as discussed below in connection with crop marketing analyzer 56 (FIG. 2). Briefly, an individual participating in the purchase/sale of commodity contracts (such as puts and calls) incurs expenses in the form of fees and other transaction costs and may receive benefits depending upon the relationship of the realized market price-yield combination vis-à-vis the terms of the commodity contract.

Accordingly, the expense and income data for commodity contract transactions can be readily incorporated into the overall financial assessment of the producer business, namely, the profit-and-loss statement. For example, the costs and fees for the transactions can be entered via the Producer Expense screen of FIG. 15A. Additionally, in regard to the Producer Risk Profile screen of FIG. 16A, the income data (gain or loss) from such transactions can be computed for each of the input price-yield data combinations and reflected in the corresponding revenue calculation.

The advantage of the functionality shown in the Producer Risk Profile screen of FIG. 16A is that various price-yield combinations can be tested to determine the corresponding revenue outcome, namely, the range of revenue values. In particular, a revenue profile can be generated as a function of variable price-yield data. Along the Revenue axis of the graph shown in FIG. 16A, the breakeven line is indicated at the 0 level, where revenue levels above and below this line indicate profit and loss, respectively. Accordingly, the indicated graph or curve can be considered a profit-and-loss measure plotted as a function of price-yield values. The revenue amount, for example, would generally be computed as the difference between income and expenses.

The information conveyed in FIG. 16A finds utility in connection with the ability of the producer to vary the parameters of the overall profit-and-loss computational model to determine the impact of varying the values of certain business and operating costs. For example, regarding the Option Analyzer screen in FIG. 11, the user can select different plan values (e.g., “Covg LVL” and “$ Level” fields) to determine how this would change the Risk Profile measurement found in FIG. 16A. For example, changes in such variables could impact the potential loss payments (indemnification amounts) and premium costs.

Generally, the user can employ the option analyzer functionality to make any manner of adjustment to the plan variables and monitor the effect such variations have on the Risk Profile. Additionally, the user can select any combination of insurance plans and scenario definitions to evaluate the consequent effect upon the financial stability of the farming operation as demonstrated by the Risk Profile screen. If desired, the values of the fields in the Producer Expense screen of FIG. 15A can also be adjusted in connection with successive generation of Risk Profile data.

The Risk Profile screen of FIG. 16A can also be utilized to determine the scenario(s) under which a desired level of revenue is achieved. Moreover, the producer can dynamically evaluate the financial impact of executing various commodity contract transactions, as a function of different price-yield combinations.

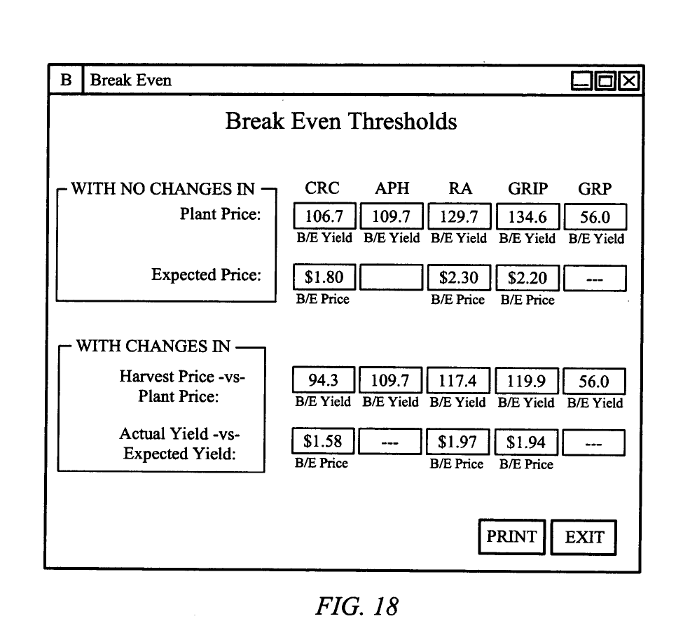

Referring back to Option Analyzer screen of FIG. 11, a user may launch a GRP analysis by selecting tab 180, corresponding to GRP analysis function 42 (FIG. 2), in order to request a performance analysis for a specific plan, namely, a Group Risk Plan. Selection of tab 180, in particular, launches the “GRP Overview” screen of FIG. 18, discussed below. Other such activation tabs may be programmed into the screen functionality to request an analysis of any of the other indicated plans.

FIG. 18 shows a computer-generated “GRP OVERVIEW” screen showing the results of the Option Analyzer performance analysis for the GRP insurance plan, based upon a variety of user-selected scenarios indicated generally at 110, namely, the indicated coverage level percentages. As shown, the analysis provides various indicia of performance, such as protection per acre, cost per acre, and total cost as correlated to the indicated trigger yield determined in accordance with the scenario selection, i.e., coverage level percentage. As shown, the user may also select a desired dollar level of protection in data field 112. Further analysis is possible with the selection of icon 114 (Historical Payments), icon 116 (Historical Percentages), and icon 118 (Rates/Quote).

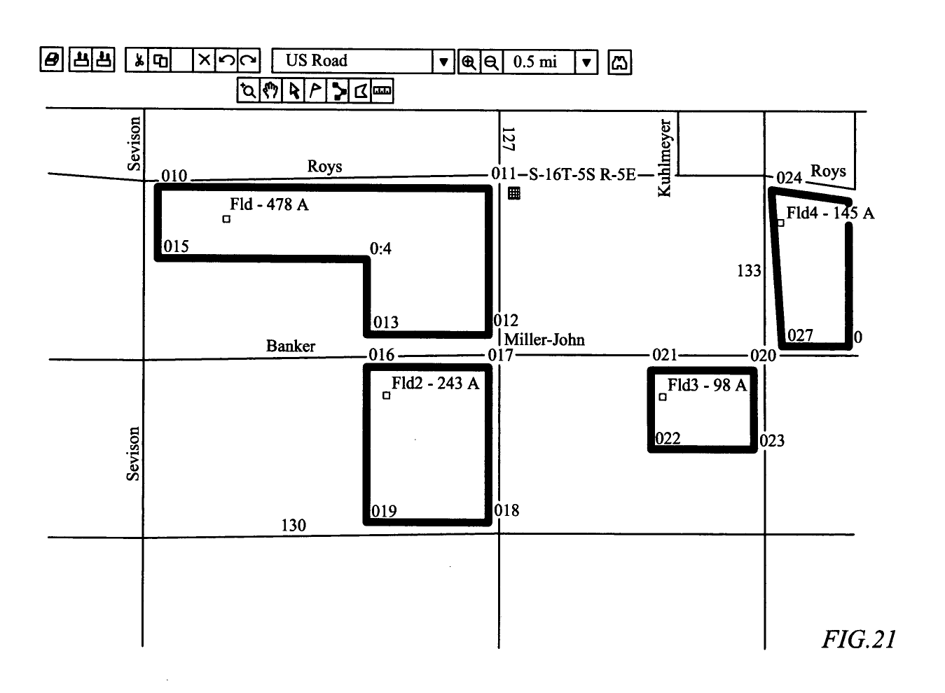

Referring to FIG. 21, there is shown a computer-generated GRP “Rates/Quote” screen that provides the user with the ability to request a determination and comparison of rates/quote data for the various coverage level scenarios shown in FIG. 18. This screen is accessible through activation of icon 118 in FIG. 18. This screen illustrates in chart form (matrix 120) the various rate and subsidy statistics as correlated to the multiple coverage level scenario selections.

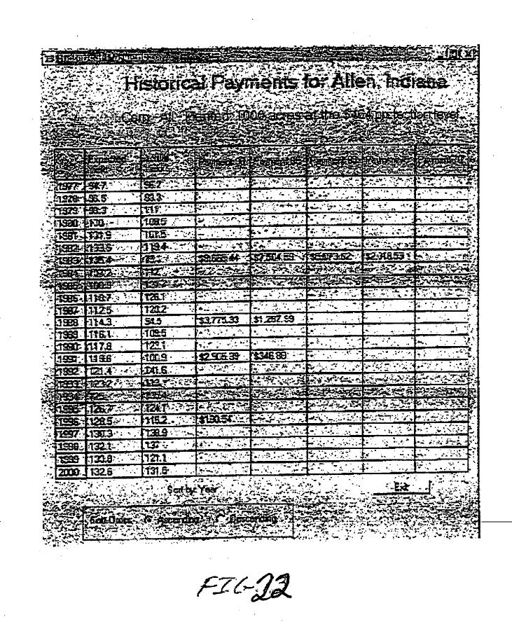

Referring to FIG. 22, there is shown a computer-generated “Historical Payments” screen that details in tabular format the historical payments that would have been made and/or were made over the specified years under the various scenarios indicated by the screen of FIG. 18. As shown, the historical payments are correlated to the actual yield and expected yield data from which the GRP historical performance results were derived. This screen is accessible by selection of icon 114 in FIG. 18.

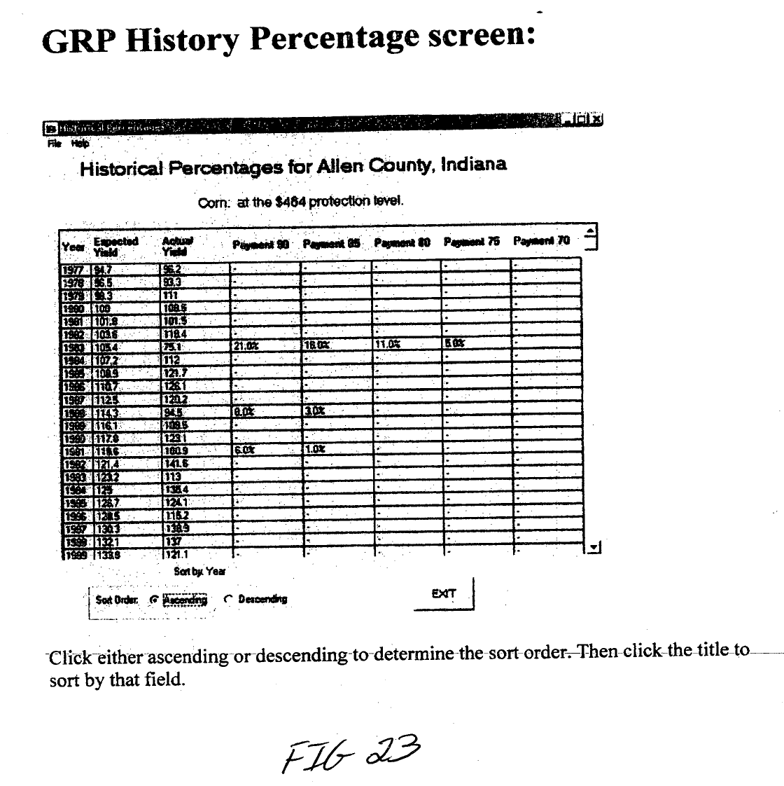

Referring to FIG. 23, there is shown a computer-generated “Historical Percentages” screen that presents the historical payments data of FIG. 22 on a percent-type basis. This screen is accessible by selection of icon 116 in FIG. 18.

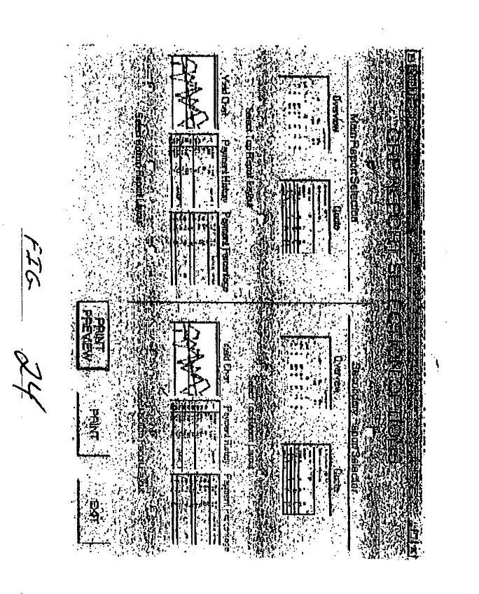

Referring to FIG. 24, there is shown a computer-generated “Report Selection” screen that allows the user to print reports concerning any of the displayed items. This screen is launched by selection of icon 115 in FIG. 18.

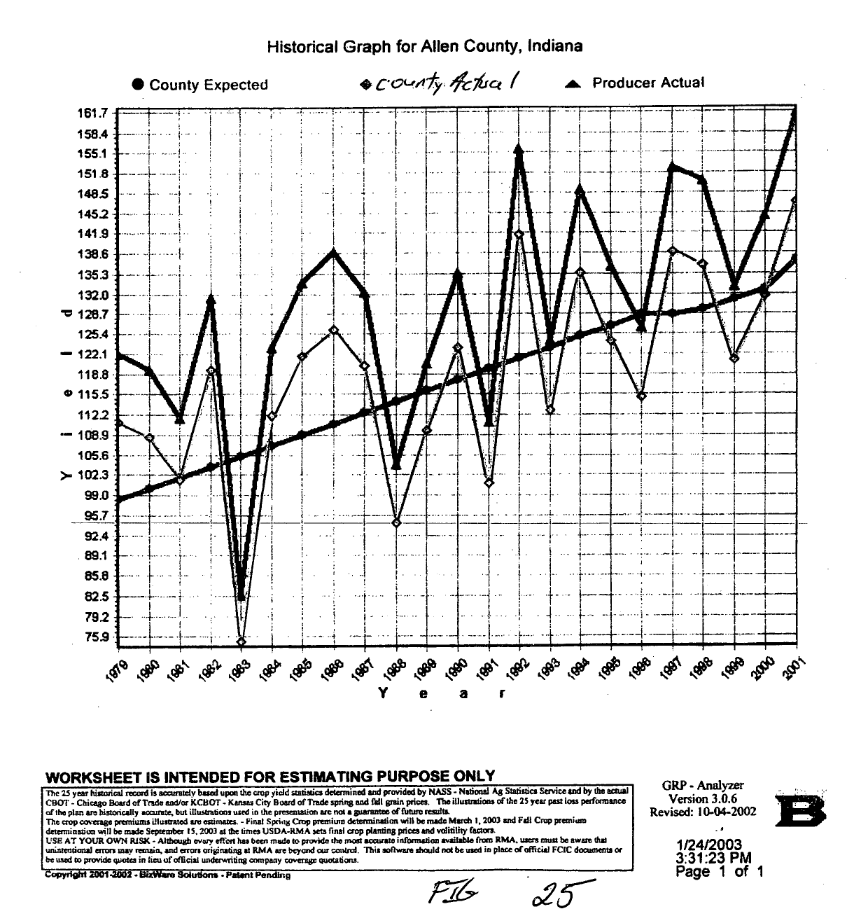

FIG. 25 shows a GRP historical yield chart that graphically compares the relevant historical yield information, namely, county expected yield, county actual yield, and producer actual yield. This report could be generated, for example, by selecting icon 119 in FIG. 18.

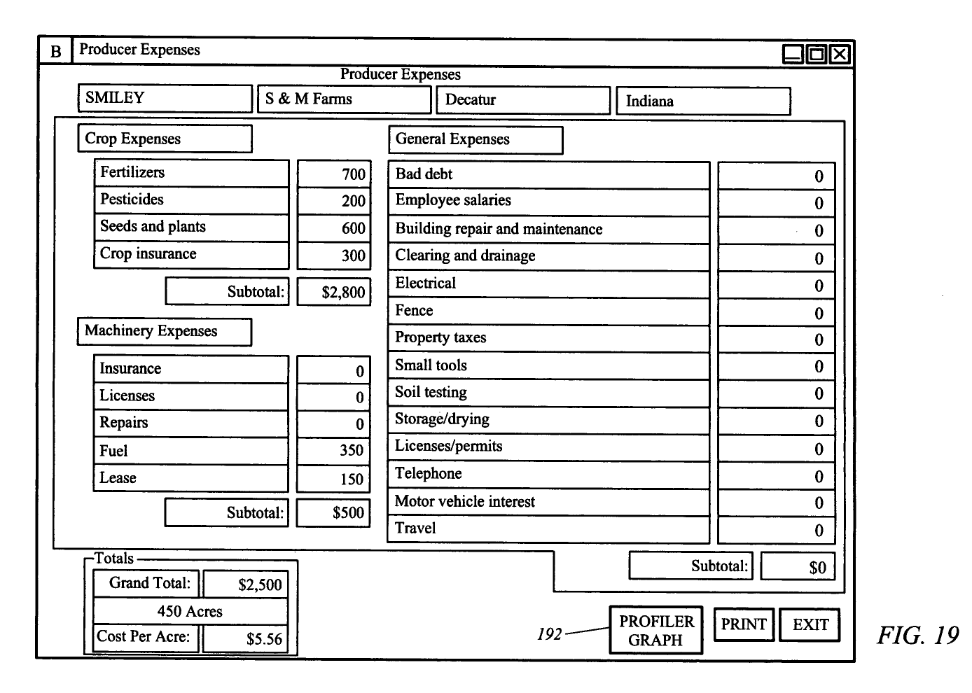

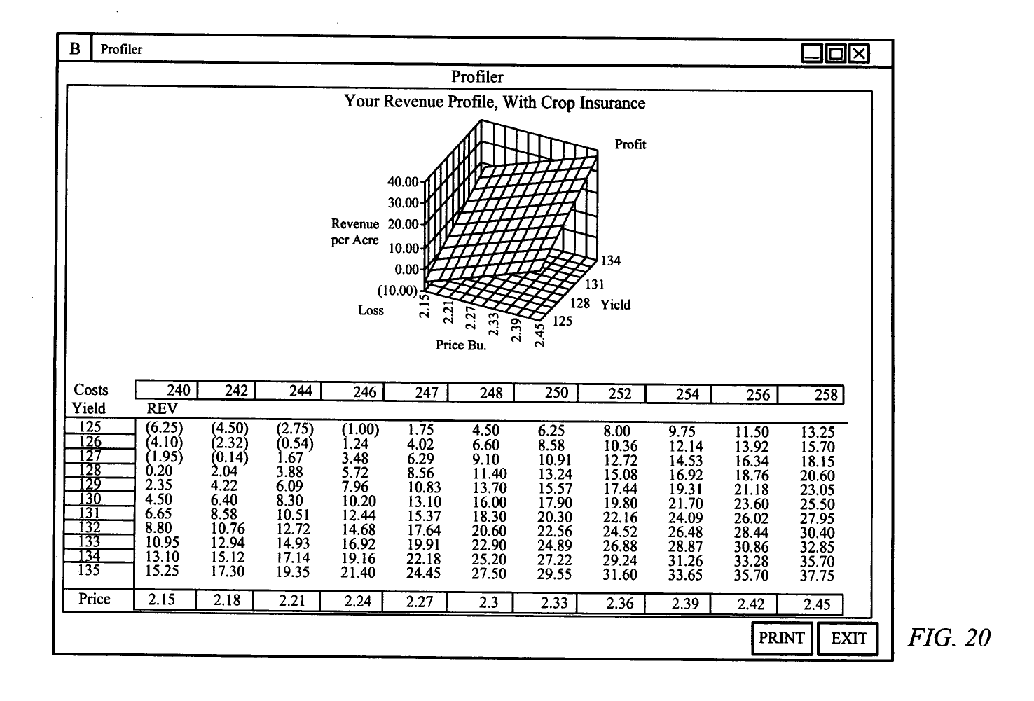

Referring to FIG. 19, a computer-generated “GRP New Case” screen allows a user to build a new case history for a producer and then request an analysis based upon this history, in conjunction with the functionality of the GRP analysis screen in FIG. 18. In particular, FIG. 20 shows a computer-generated “GRP Case History” screen with historical yield data (similar to FIG. 7) for the indicated PRODUCER for the specified time period.

Although the analysis functionality described in conjunction with the computer-generated screens of 18-25 relates to a multi-scenario historical plan performance for a GRP-type plan (implementing GRP analysis 42 in FIG. 2), this disclosure is merely illustrative and should not be considered in limitation of the invention. Rather, it should be apparent that similar analyses may be performed in conjunction with other plans, e.g., implementations of GRIP analysis 44 and other plan analysis 46 (FIG. 2).

Referring again to other functional aspects of the system in FIG. 2, a company product profit and loss (P&L) analyzer function 54 can be implemented in accordance with the option analyzer results. For example, a sales agent or insurance company can execute an option analysis for the plans carried, written or under contract to determine the accounting effect of writing or carrying such plans, namely, on a profit and loss basis.

Furthermore, a crop marketing analyzer function 56 is provided. Crop analyzer 56 would be integrated with the Option Analyzer, the Producer Expenses, and the Producer Profile. Crop marketing has its own set of unique costs and benefits. A producer can “purchase” commodity contracts (puts, calls) of forward delivery contracts and each type of transaction has variable fees (depending on the dollar amounts, options, quantity of the commodity selected, and the brokerage costs) and variable benefits (that would take effect depending on the final outcomes of commodity prices and crop yields).

These marketing plans can be employed regardless of the crop insurance plan(s) selected. These marketing plans will have a variety of impacts on the producer's bottom line (profit or loss). This module will incorporate a producer's marketing plan into the producer's profile results and so demonstrate the net effect with all the requested plans of insurance comparisons and what-if projections.

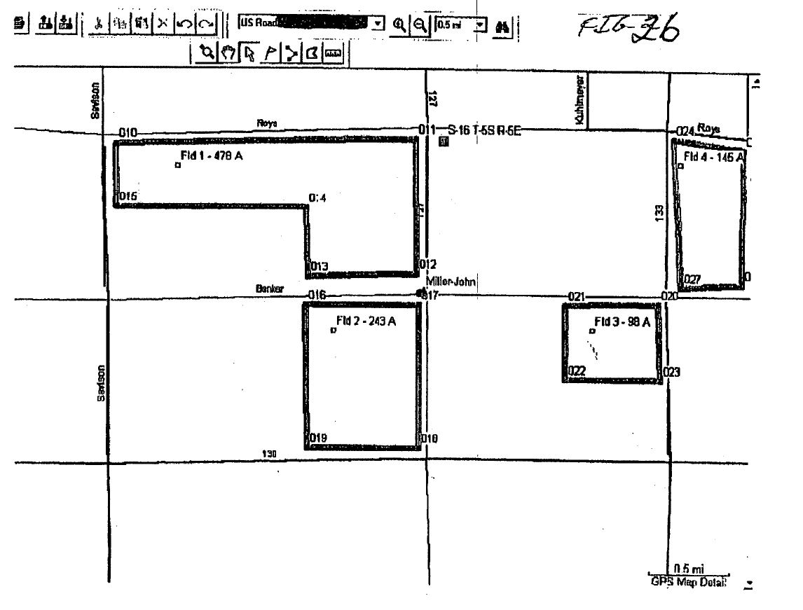

FIG. 2 also shows a farm map acreage builder function 58 and a farm map for rated ground function 60 that enables a user to construct and generate a visual and graphical representation of the relevant farming property and correlate the property depiction to the federal government rating structure. FIG. 26 shows one example of a computer-generated screen provided by a software-based implementation of this function. A maps source database 62 can provide the relevant mapping information and can be constructed or provided according to any conventional means. Maps source database 62 acts as the storage location for elements 58-60 and is included in element 18 of FIG. 1. Database 62 can be incorporated into database environment 18 of FIG. 1.

Referring to FIG. 26, acreage builder 58 (FIG. 2) generates information that would be stored and maintained (along with correlating yield histories) in the Producers Database 28. This would be carried forward into the screens for Comparison 40 and Analyzer 48. This would also be the source for the Federal Legal land system particulars (such as section-township-range).

For purposes of implementing acreage builder 58, there will be provided suitable geographical and map-building tools for constructing a map such as that shown in FIG. 26. Any conventional tools can be used, such as graphical or computer-based design tools, e.g., CAD software. A user may be able to select the parameters for constructing such a map. For example, the user can select map criteria such as all insurable plots of land within a zone of interest, e.g., the relevant county encompassing the user land. The maps can be marked with pertinent information such as geographical coordinates (e.g., GPS data), the size and owner of each plot, the type of crop being grown in each plot, and any rating data. The maps may also be furnished with markings identifying any significant land or commercial features. The maps may also bear roadway information.

Rated ground function 60 originates from FCIC (government) and is technically part of the “Government Database” (element 36) but is likely to be treated as a stand-alone component due to its immense size. It particularly/graphically shows a “risk rating” for every insurable piece of ground in the country. Some products have premium rate differentials (increases) for “high-risk” or “rated” ground area.

The database information indicated by insured producer data 64 and RMA/Actuary/Rates data 66 (FIG. 2) would correspond, for example, to comparable data structures found in database environment 18 of FIG. 1. Similarly, the CBOT-NYCE and KCBOT-OTHER data structures 70 can be provided in any known means, such as by network access to relevant exchange board networks or other industry means that furnish commodity pricing data.

As discussed previously, the invention incorporates a hail quote and management facility 68 (FIG. 2) into the practice of the invention, such that any plan-related functions and operations of the invention are equally available with private crop hail insurance policies.

According to another feature of the invention, an internet-based producer self-serve function 72 (FIG. 2) enables an end user to practice the invention in conjunction with an internet-based network connection. For example, as discussed previously, an end user can have the software resident locally while retrieving the other relevant data (e.g., historical information, government and county-released figures) over an internet connection from a central database that is maintained for the purposes of the invention, for example.

Other auxiliary functions may be provided by crop customer management system function 74 and company database E.D.I. (Electronic Data Interchange) 76 (FIG. 2).

There is an existing Customer Management System 74 (FIG. 2) in use by several agencies (another BizWare product). It is intended that this Customer Management System database will be integrated with the database repository of the invention. This will allow free flow and error free common access to the common information from both application suites.

With respect to E.D.I., all underwriting companies have existing policy management software systems. It is intended to have an electric transferal of common information between the invention's Producer/Customer Database and the various contracted company database systems. This will allow quick, efficient loading both ways, eliminating manual re-keying of data and reducing mistakes, time, and effort. This will also provide the invention with data and rates for company specific product options, rates, and private hail product information.

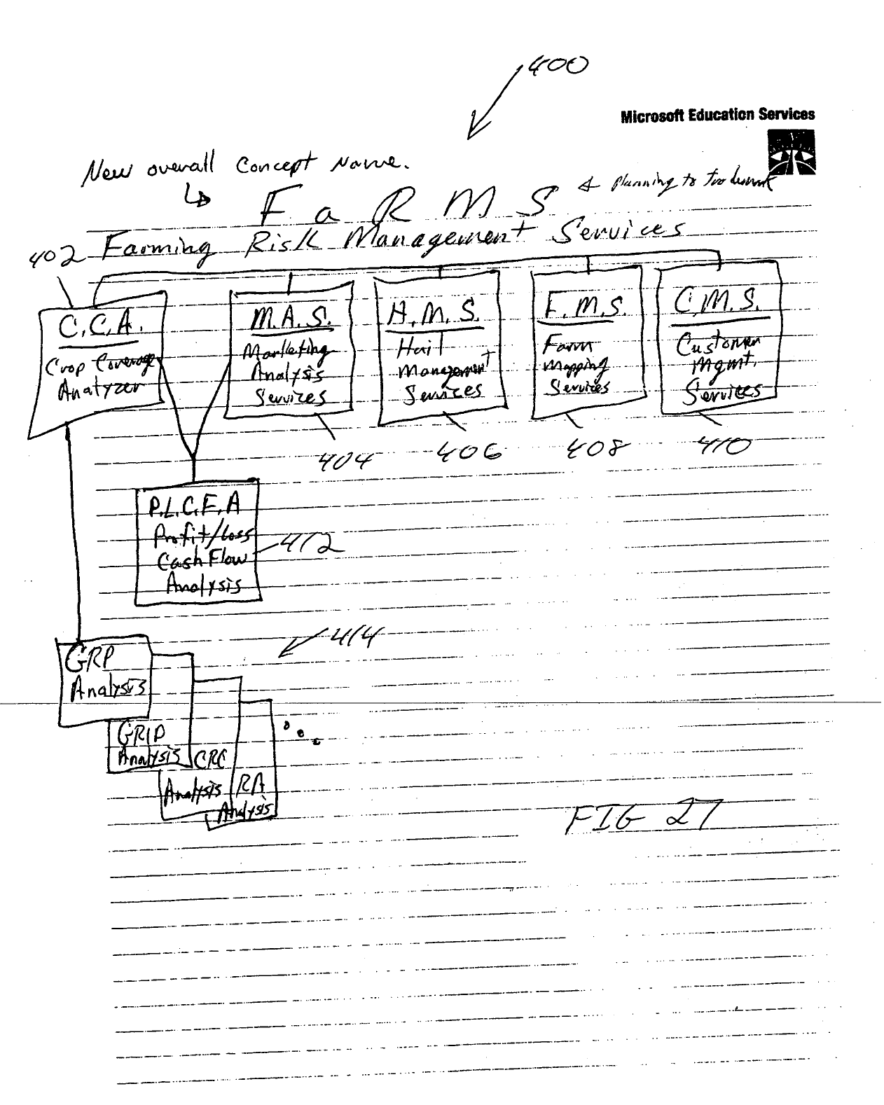

Referring now to FIG. 27, there is shown a block diagram of one alternate form of the invention, illustrating in modular form an arrangement of services provided in conjunction with the practice of the invention. The illustrated farming risk management service suite 400 includes a crop coverage analyzer 402, a marketing analysis service 404, a hail management service 406, a farm mapping service 408, and a customer management service 410. In one form, these services may be considered primary or front-line services in the sense that they perform initial analysis functions. By comparison, profit/loss and cashflow analysis service 412 uses the analysis results from the primary services to render secondary or derivative analysis that are thereby based upon the outcomes and results from such primary analysis services.

The functionality of service units 402, 404, 406, 408, 410, and 412 generally may be considered to correspond logically to modules 40/48, 56, 68, 58, 74, and 50/52 in FIG. 2, respectively.

The illustrated service environment 400 also includes the various individual insurance plan analysis units generally indicated at 414 that are employed by crop coverage analyzer 402 to perform the historical product comparisons and plan option analyses. The array of plan analysis units 414 correspond collectively and logically to elements 42, 44, 46 in FIG. 2, for example.

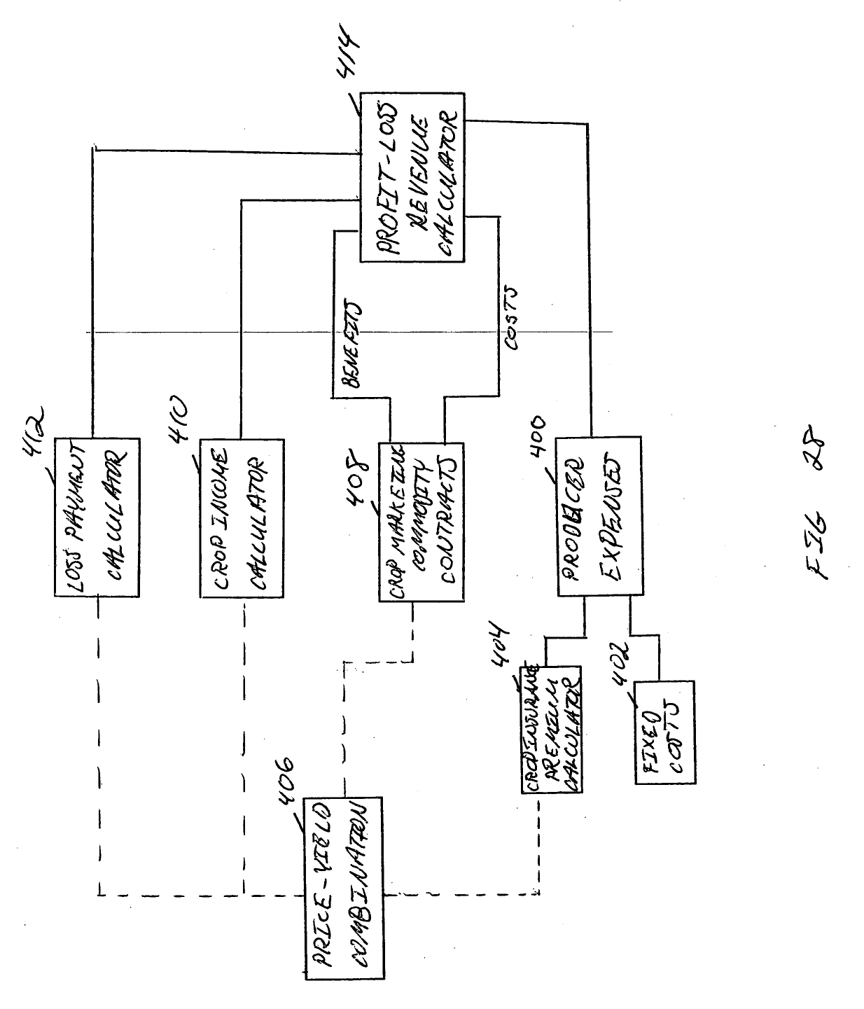

Referring to FIG. 28, there is shown a flow diagram illustrating an end-to-end analysis sequence depicting one possible operating session during practice of the invention. In particular, the diagram depicts the various analysis routines and data results employed to render a financial evaluation, such as might be ultimately demonstrated by the Risk Profile screen of FIG. 16A.

For ease of description, the flow diagram of FIG. 28 is generally organized by the contributions to income and expense. Regarding the expense components, the expense items include, but are not limited to, producer expenses comprising fixed costs 402 and premium amounts computed by crop insurance premium calculator 404, based upon the price-yield data combination 406. Also, expense costs are attributed to transactions from crop marketing commodity contracts 408.

Regarding the income components, the income items include, but are not limited to, crop income computed by crop income calculator 401, based upon the price-yield data combination 406. Additionally, indemnification amounts potentially received by the farmer are computed by loss payment calculator 412, based upon the price-yield data combination 406. Also, income may be attributable to any benefits derived from the performance of the commodity contracts 408, based upon the price-yield data combination 406.

A profit-loss revenue calculator 414 computes the overall revenue or risk profile in response to the various input data pertaining to the income and expense components. For example, a profit-loss x-y-z graph or spreadsheet table may be produced, which plots the revenue as a function of various individual price-yield data combinations, such as in the screen of FIG. 16A.

Regarding FIGS. 27 and 28, it is apparent that all of the functions disclosed therein and their integral interaction are facilitated and otherwise performed by the invention discussed herein, such as the systems depicted in FIGS. 1-3 and the related computer-generated screens.

The invention provides numerous advantages. For example, the invention has combined highly-compressed extensive data and the approach of calculating performance history, as well as compiling a producer performance history, for the purpose of demonstrating the value of a crop insurance product to an individual farmer. This functionality provides an awareness and understanding into the value and functionality of crop insurance.

Moreover, the invention provides the ability to quickly and accurately quote numerous products, for numerous crops, with all the variations and options that this tool set allows, enabling agents to properly service customers more efficiently.

Additionally, by providing highly-compressed stored information available on a single laptop computer, the invention avoids the conventional undertakings of examining large volumes of books, binders, forms, maps and documents.

Moreover, with the approach of demonstrating all coverages and options and types of policies and allowing the numerous “what-if” variations to be applied to yield and prices, for example, it is possible to acquire a fuller understanding of how crop insurance works and potentially performs for a customer under specific conditions. The customer can then make a properly informed decision on the coverage best suited to the farm operation.

The invention also allows access to continually updated current data. In particular, on-line database updates of the software suite will allow end-users to dynamically change and receive all the numerous pricing, price volatility, ratings, and yield updates as they occur throughout the sales and farming season.

Furthermore, detailed product analysis is available for all multi-peril products (such as the GRP and GRIP modules). Commercial Internet access is available for users such as crop insurance agents and customers. An Electronic Data Interchange network connection is available between underwriting company databases and the end-user agent customer databases, to facilitate company product updates and allow the agent to conduct the contracting business with the most recent insurance plan versions.

The invention also supports integration of underwriting company crop hail system and the farm mapping/acreage builder/hail quote modules into the overall software tool suite.

Also, cash flow and profit and loss analysis can be performed for crop producers.

Moreover, underwriting company statistics and information support and related profit and loss analysis is also available. In addition, crop commodity marketing options can be explored, and those choices and decisions can be factored into the producer's overall crop coverage decision and farming operation profitability, fully analyzing their operation's risks over many end result combinations of prices and yields. Also, by retaining a producer's information, they can be serviced in subsequent years in a highly efficient manner. They will also be provided an exacting awareness of hindsight as to their previous choices for crop coverage and be able to use the insight to formulate their upcoming decisions.

Referring back to FIG. 1, it should be apparent that the interaction and cooperation between the applications software and database environments of the invention can take a variety of suitable forms. For example, in a network configuration, the illustrated databases can be centrally located at an archival facility, while the applications software can be located at an end-user location, e.g., the business or home of a farmer or the office of an insurance sales agent. Any suitable network connection known to those skilled in the art can be used to establish communications between the database environment 18 and the remote user device, such as an internet access connection (e.g., World Wide Web).

In order to facilitate automated updating of the database information, the illustrated database environment 18 will preferably be equipped with a smart-type or intelligent management feature that accesses, queries, interrogates, and otherwise monitors the information status of the particular reporting agencies that are responsible for issuing information needed to implement certain plans.

For example, database connections may be established with the FCIC, RMA (Risk Management Agency)—Office of Risk Management, CBOT, KCBOT, and county organizations to retrieve plan-related information as it is released, in order to update the database and enable final implementation of crop insurance plans that rely on such in-season, harvest, and/or post-harvest information. Of course, this automated data collection feature is viable only to the extent such information can be released and made available by accessible electronic means. Otherwise, the information would have to be updated manually or by using some combination of manual and electronic updating. It should be apparent, however, that any updating mechanism and methodology can be used within the scope of the present invention.

The appropriate databases will also be updated with the applicable information to maintain the historical databases, such as commodity pricing, yield data (both group and individual actual production), revenue, and income, both on a county-wide and individual producer basis.

In this implementation, where the databases are located remotely from the end-user, the applications software would have a log-in feature that accesses the databases at the appropriate time to download the pertinent information needed to practice the invention, e.g., perform the product comparison and the options analysis.

It should be apparent that any information gathering and collection techniques known to those skilled in the art may be used to acquire the information to maintain, service, and update the databases. Moreover, the process of maintaining such databases and managing and controlling the data collection efforts can be implemented with any suitable database administrator (e.g., software-based) known to those skilled in the art. The databases can be created and constructed using conventional technology.

In an alternate form, the databases may be provided along with the applications software as a unit package to be run on the end-user computer platform. For example, the databases can be provided on an alterable CD-ROM. For this purpose, the consolidated computer product would have an updating feature that requests and/or receives downloads (e.g., from the central database facility) to refresh and update the databases.

Additional information about crop insurance plans may be obtained from the internet sites www.usda.gov, www3.rma.usda.gov, and www.act.fcic.usda.gov, the contents of which are incorporated herein by reference thereto.

The invention also provides an insurance risk management service facility that determines best options scenario(s), namely, execution of a crop coverage and risk analysis that determines the best coverage options for the farming operations. The analysis and review is preferably conducted across all crop insurance plans and options. The farm mapping service provides a nationwide satellite-based GPS mapping and imaging functionality, which reports production and/or planted acres/plots in a map format display.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for use with a plurality of crop insurance plans, said method comprising the steps of:
providing information pertaining to said plurality of crop insurance plans; and
generating at least one indication of performance of at least one crop insurance plan under at least one scenario, utilizing the information.

2. The method as recited in claim 1, wherein the generating step further includes the step of:
determining performance of at least one crop insurance plan on at least one of an historical basis, a current actual basis, a hypothetical basis, a forecast basis, an estimated basis, a projected basis, and a predicted basis.

3. The method as recited in claim 2, further includes the step of:
associating an historical-based performance determination with historical information furnished by the information providing step and utilized by the performance indication generating step to render the historical performance determination.

4. The method as recited in claim 2, further includes the step of:
performing a performance trend analysis based upon a projection-based crop insurance plan performance determination, and generating an indication thereof.

5. The method as recited in claim 1, wherein the generating step further includes the step of:
determining historical performance of at least one crop insurance plan utilizing at least one of price-related historical data, yield-related historical data, revenue-related historical data, and income-related historical data.

6. The method as recited in claim 1, wherein the generating step further includes the step of:
constructing a comparison defining the relative performance of at least one crop insurance plan under at least one scenario.

7. The method as recited in claim 6, wherein the comparison construction step further includes the step of:
determining performance of at least one crop insurance plan based upon at least one of an historical basis, a current actual basis, and a projected basis.

8. The method as recited in claim 6, wherein the comparison construction step further includes the step of:
providing a comparative demonstration of (i) individual producer-based performance regarding at least one individual producer-based crop insurance plan, and (ii) group-based performance regarding at least one group-based crop insurance plan.

9. The method as recited in claim 1, wherein the generating step further includes the step of:
determining at least one projected and/or hypothetical performance for at least one crop insurance plan utilizing at least one assumption concerning at least one crop insurance plan variable.

10. The method as recited in claim 1, further includes the steps of:
defining at least one hypothetical scenario for at least one crop insurance plan; and
determining the behavior of at least one crop insurance plan in response to the at least one hypothetical scenario.

11. The method as recited in claim 1, further includes the steps of:
selectively iteratively redefining the at least one scenario by selectively modifying the information pertaining to said plurality of crop insurance plans; and
repeating the performance generating step for each iteration of scenario redefinition.

12. The method as recited in claim 1, further includes the steps of:
selectively iteratively performing the steps of:
selectively providing a value and/or setting for at least one modifiable crop insurance plan variable, and
utilizing the value and/or setting in the generating step.

13. The method as recited in claim 1, wherein the information providing step further includes the step of:
receiving at least one user value and/or selection pertaining to at least one factor and/or variable of at least one crop insurance plan.

14. The method as recited in claim 1, further includes the step of:
determining a best-case scenario for at least one crop insurance plan, according to a selective performance criteria.

15. The method as recited in claim 14, wherein the determining step further includes the step of:
varying the value of at least one user-specifiable crop insurance plan variable for at least one crop insurance plan, until the performance criteria is met.

16. The method as recited in claim 1, wherein the generating step further includes the step of:
selecting at least one performance level to which the performance of at least one crop insurance plan need conform and/or comply.

17. The method as recited in claim 16, wherein the generating step further includes with respect to at least one crop insurance plan subject to performance level conformity and/or compliance the steps of:
maintaining at least one plan variable substantially constant; and
adjusting at least one plan variable until achieving performance level conformity and/or compliance.

18. The method as recited in claim 16, wherein the generating step further includes with respect to at least one crop insurance plan subject to performance level conformity and/or compliance the step of:
dynamically adjusting at least one plan variable until achieving performance level conformity and/or compliance.

19. The method as recited in claim 16, wherein the at least one performance level includes a break-even threshold.

20. The method as recited in claim 1, further includes the steps of:
selectively defining at least one scenario; and
determining the value of at least one variable of at least one crop insurance plan enabling satisfaction of a break-even performance requirement, under the at least one scenario definition.

21. The method as recited in claim 20, wherein the at least one variable associated with the break-even performance requirement includes a price-related variable and/or a yield-related variable.

22. The method as recited in claim 1, wherein the at least one crop insurance plan includes at least one hail-related policy.

23. The method as recited in claim 1, further includes the step of:
performing a business and/or financial analysis incorporating results from the generating step.

24. The method as recited in claim 23, wherein the business and/or financial analysis performing step further includes the step of:
evaluating the effect and/or impact of actually and/or possibly carrying crop insurance on at least one of an expense-related business component, revenue-related business component, income-related business component, profit-related business component, loss-related business component, and cash flow-related business component.

25. The method as recited in claim 1, further includes the step of:
specifying each crop insurance plan in association with a respective insurance provider carrying the associated crop insurance plan; and
causing the generating step to further construct a comparison of the relative performance of same-type crop insurance plans associated with respective insurance providers.

26. The method as recited in claim 1, wherein the information providing step further includes the step of:
a user furnishing information pertaining to at least one insurance-applicant related crop insurance plan variable; and
accessing a database to retrieve therefrom at least one of individual producer actual production history, county-based and/or group-based price history data and/or yield history data, crop insurance plan policy provision information, crop insurance rating data, crop actuarial history data, crop insurance actuarial information, county-based crop history data, commodity pricing history data, and county-based and/or producer-based historical revenue data and/or historical income data.

27. The method as recited in claim 26, wherein the at least one insurance-applicant related crop insurance plan variable pertains to at least one of price election, coverage level, and protection level.

28. A method for use with a plurality of crop insurance plans, said method comprising the steps of:
providing information pertaining to at least one crop insurance plan; and
determining at least one indicia of behavior of at least one crop insurance plan, responsive to and in accordance with the information.

29. The method as recited in claim 28, wherein the behavior determination being made upon at least one of an historical basis, a current actual basis, a hypothetical basis, a forecast basis, a predicted basis, and a projected basis.

30. The method as recited in claim 28, wherein the determining step further includes the step of:
generating a comparison of the relative historical behaviors of at least one crop insurance plan under at least one scenario.

31. The method as recited in claim 28, wherein the information providing step further includes the step of:
selectively defining at least one modifiable crop insurance plan scenario having at least one variable associated therewith, for use as information by the behavior determining step.

32. The method as recited in claim 31, further includes the steps of:
dynamically modifying at least one variable of at least one crop insurance plan; and
selectively repeating the determining step in relation to respective variable modifications and/or scenario redefinitions.

33. The method as recited in claim 28, wherein the determining step further includes the step of:
determining projected and/or hypothetical performance of at least one crop insurance plan, on the basis of at least one crop insurance plan variable assumption.

34. The method as recited in claim 28, further includes the steps of:
defining at least one hypothetical scenario for at least one crop insurance plan; and
determining the behavior of at least one crop insurance plan in response to the at least one hypothetical scenario.

35. The method as recited in claim 28, further includes the steps of:
selecting at least one basis for analyzing, evaluating, and/or comparing at least one crop insurance plan under at least one selective scenario; and
implementing the at least one basis selection in connection with performance of the determining step.

36. The method as recited in claim 35, wherein the at least one basis selection includes at least one of an historical relative performance comparison, a projected and/or hypothetical relative performance comparison, a performance analysis based at least in part upon assumptions, a scenario-based comparison and/or analysis, a plan-based comparison and/or analysis, a combination of scenario-based and plan-based comparison and/or analysis, a comparison and/or analysis among individual producer-based crop insurance plans, a comparison and/or analysis among group-based crop insurance plans, and a comparison and/or analysis among a combination of individual producer-based crop insurance plans and group-based crop insurance plans.

37. A computer program product for use in a computer environment, the computer program product comprising a computer usable medium having computer readable program code thereon executable by the computer environment, the computer readable program code for performing a method to facilitate the evaluation of at least one crop insurance plan, said method comprising the steps of:
receiving information pertaining to the at least one crop insurance plan; and
processing the information to determine at least one indicia of performance of at least one crop insurance plan under at least one scenario.

38. The computer program product as recited in claim 37, wherein said processing step further includes the step of:
determining the relative historical performance of at least one crop insurance plan, according to at least one scenario.

39. The computer program product as recited in claim 38, wherein the determining step further includes the step of:
utilizing yield-related and/or price-related historical information, as provided by the receiving step.

40. The computer program product as recited in claim 37, wherein the processing step further includes the step of:
generating a comparison demonstrating the relative historical performance of at least one crop insurance plan under at least one scenario.

41. The computer program product as recited in claim 37, wherein the processing step further includes the steps of:
performing at least one of:
determining at least one projected and/or hypothetical performance for at least one crop insurance plan utilizing at least one assumption concerning at least one crop insurance plan variable, and
determining at least one current actual performance for at least one crop insurance plan.

42. The computer program product as recited in claim 37, wherein said method further includes the steps of:
defining at least one hypothetical scenario for at least one crop insurance plan; and
determining the behavior of at least one crop insurance plan in response to the at least one hypothetical scenario.

43. The computer program product as recited in claim 37, wherein said method further includes the step of:
performing a business and/or financial analysis incorporating results from the processing step.

44. The computer program product as recited in claim 37, herein said method further includes the steps of:
integrating multiple crop insurance plans into a consolidated quotation and management package to thereby enable an analysis of all available crop insurance plans.

45. A computer program product for use in a computer environment, the computer program product comprising a computer usable medium having computer readable program code thereon executable by the computer environment, the computer readable program code for performing operations to facilitate evaluation and/or analysis of at least one crop insurance plan, said operations comprising:
processing information pertaining to at least one crop insurance plan operative under at least one scenario; and
providing at least one indicia of performance of at least one crop insurance plan, based at least in part upon the processing results.

46. The computer program product as recited in claim 45, wherein said operations further include:
determining the relative historical performance of at least one crop insurance plan under at least one scenario.

47. The computer program product as recited in claim 45, wherein said operations further include:
generating a comparison demonstrating the relative historical performance of at least one crop insurance plan under at least one scenario.

48. The computer program product as recited in claim 45, wherein said operations further include at least one of:
determining at least one projected and/or hypothetical performance for at least one crop insurance plan utilizing at least one assumption concerning at least one crop insurance plan variable, and
determining at least one current actual performance for at least one crop insurance plan.

49. The computer program product as recited in claim 45, wherein said method further includes the steps of:
defining at least one hypothetical scenario for at least one crop insurance plan; and
determining the behavior of at least one crop insurance plan in response to the at least one hypothetical scenario.

50. The computer program product as recited in claim 45, wherein said operations further include:
performing a business and/or financial analysis incorporating the processing operation results.

51. The computer program product as recited in claim 45, wherein said operations further include:
integrating multiple crop insurance plans into a consolidated quotation and management package to thereby enable an analysis of all available crop insurance plans.

52. A system, comprising:
an input device;
a module containing at least one of representations, descriptions, and definitions of at least one crop insurance plan;
a computing device operatively coupled to said input device and said module; and
a storage apparatus including program code executable by said computing device;
said program code being configured to operatively determine at least one indicia of performance of at least one crop insurance plan, based at least in part upon information operatively received from said input device pertaining to said at least one crop insurance plan.

53. The system as recited in claim 52, wherein said program code being configured further to determine relative historical performance of at least one crop insurance plan under at least one scenario, in association with historical information.

54. The system as recited in claim 53, further includes:
a database operatively coupled to said computing device, said database containing crop-related historical information.

55. The system as recited in claim 52, wherein said program code being configured further to (i) determine a projected and/or hypothetical performance of at least one crop insurance plan, based at least in part upon information operatively received from said input device pertaining to at least one assumption concerning at least one crop insurance plan variable, and/or (ii) determine at least one current actual performance of at least one crop insurance plan.

56. The system as recited in claim 52, wherein said program code being configured further to define at least one hypothetical scenario for at least one crop insurance plan and to determine the behavior of at least one crop insurance plan in response to the at least one hypothetical scenario.

57. The system as recited in claim 52, wherein said input device being disposed remote from said computing device.

58. The system as recited in claim 57, further includes:
a network connection between said input device and said computing device.

59. The system as recited in claim 52, wherein said module further includes:
a means defining at least one algorithm having at least one formula.

60. The system as recited in claim 52, wherein said program code being configured further to perform a business and/or financial analysis incorporating results from the crop insurance plan performance determination.

61. The system as recited in claim 52, wherein said program code being configured for integrating multiple crop insurance plans into a consolidated quotation and management package to thereby enable an analysis of all available crop insurance plans.

62. A system, comprising:
first means to define at least one crop insurance plan;
second means to provide variable information pertaining to said at least one crop insurance plan; and
third means, operatively coupled to said first means and responsive to variable information from said second means, to determine at least one indicia of performance of at least one crop insurance plan under at least one scenario.

63. The system as recited in claim 62, further includes:
means for providing historical information.

64. The system as recited in claim 63, wherein said third means further includes:
means for determining the relative historical performance of at least one crop insurance plan under at least one scenario, based at least in part upon the historical information.

65. The system as recited in claim 62, wherein said third means further includes:
means for constructing a comparison defining the relative historical performance of at least one crop insurance plan under at least one scenario, based at least in part upon at least one of yield-related historical data and price-related historical data.

66. The system as recited in claim 62, wherein said third means further includes:
means for determining projected and/or hypothetical performance of at least one crop insurance plan under at least one scenario, based at least in part upon at least one crop insurance plan variable assumption operatively provided by said second means.

67. The system as recited in claim 66, wherein said means for determining projected and/or hypothetical performance further includes:
means for demonstrating the determination of projected and/or hypothetical crop insurance plan performance as a comparison.

68. The system as recited in claim 62, wherein said third means further includes:
means for defining at least one hypothetical scenario for at least one crop insurance plan; and
means for determining the behavior of at least one crop insurance plan in response to the at least one hypothetical scenario.

69. A system, comprising:
a computer environment including at least one processor; and
program code executable by said at least one processor;
said program code being configured to determine at least one indicia of performance of at least one crop insurance plan under at least one scenario, in response to input data pertaining to at least one crop insurance plan.

70. The system as recited in claim 69, wherein the input data includes at least one user selection pertaining to at least one crop insurance plan variable.

71. The system as recited in claim 69, further includes:
means to define the at least one crop insurance plan.

72. The system as recited in claim 69, wherein said program ode being configured further to determine relative historical performance of at least one crop insurance plan under at least one scenario, in association with historical information.

73. The system as recited in claim 72, further includes:
a database containing crop-related historical information, said database being operatively coupled to said computer environment.

74. The system as recited in claim 69, wherein said program code being configured further to (i) determine a projected and/or hypothetical performance for at least one crop insurance plan, based at least in part upon at least one assumption concerning at least one crop insurance plan variable, and/or (ii) determine a current actual performance for at least one crop insurance plan.

75. The system as recited in claim 69, wherein said program code being configured further to define at least one hypothetical scenario for at least one crop insurance plan and to determine the behavior of at least one crop insurance plan in response to the at least one hypothetical scenario.

76. An apparatus, comprising:
an input device;
a storage device containing at least one of representations, descriptions, and definitions of at least one crop insurance plan; and
a processor operatively connected to said input device and said storage device;
said processor including a crop insurance plan performance calculator.

77. The apparatus as recited in claim 76, wherein said processor further includes:
a crop insurance plan performance analyzer.

78. The apparatus as recited in claim 76, wherein said processor further includes:
a crop insurance plan relative performance comparator.

79. The apparatus as recited in claim 76, further includes:
at least one database containing yield-related and/or price related historical information.

80. The apparatus as recited in claim 79, wherein said at least one database further includes at least one of:
a data structure containing information representative of current and/or historical crop insurance rates;
a data structure containing information representative of crop actuarial history;
a data structure containing information representative of current and/or historical commodity pricing;
a data structure containing information representative of individual producer actual production history;
a data structure containing information representative of county-based and/or group-based crop history; and
a data structure containing information representative of current and/or historical insurance plan actuarial data.

81. A computer program product for use in a computer environment, the computer program product comprising a computer usable medium having computer readable program code thereon executable by the computer environment, the computer readable program code comprising:
first program code for defining and/or representing at least one crop insurance plan; and
second program code operatively associated with said first program code, said second program code for determining at least one indicia of performance of at least one crop insurance plan, responsive to and in accordance with input data pertaining to at least one crop insurance plan variable.

82. The computer program product as recited in claim 81, further includes:
program code for generating a relative historical performance comparison involving at least one crop insurance plan according to at least one scenario.

83. The computer program product as recited in claim 82, further includes:
a database containing crop-related historical information.

84. The computer program product as recited in claim 81, further includes:
program code for determining historical performance of at least one crop insurance plan under at least one scenario.

85. The computer program product as recited in claim 81, further includes:
program code for determining a projected and/or hypothetical performance of at least one crop insurance plan, based at least in part upon at least one assumption concerning at least one crop insurance plan variable.

86. The computer program product as recited in claim 85, further includes:
program code for developing trending information, based at least in part upon the determination of projected and/or hypothetical performance.

87. The computer program product as recited in claim 81, further includes:
program code for defining at least one hypothetical scenario for at least one crop insurance plan; and
program code for determining the behavior of at least one crop insurance plan in response to the at least one hypothetical scenario.

88. The computer program product as recited in claim 81, further includes:
program code for performing a business and/or financial analysis incorporating results from the crop insurance plan performance determination.

89. The computer program product as recited in claim 81, further includes:
program code for integrating multiple crop insurance plans into a consolidated quotation and management package to thereby enable an analysis of all available crop insurance plans.

90. A computer usable medium having computer readable program code thereon executable by a computer system, the computer readable program code comprising:
first program code to represent at least one crop insurance plan;
second program code, operatively associated with said first program code, to process input information pertaining to the at least one crop insurance plan; and
third program code to determine at least one indicia of performance of at least one crop insurance plan, according to processing results of said second program code.

91. The computer usable medium as recited in claim 90, further includes:
at least one data structure containing crop-related historical information.

92. The computer usable medium as recited in claim 91, wherein said at least one data structure further includes:
a database containing historical information pertaining to at least one of price-related history, yield-related history, individual producer actual production history, crop insurance plan actuarial history, county-based and/or group-based crop history, crop insurance rate history, crop actuarial history, and commodity pricing history

93. The computer usable medium as recited in claim 90, wherein said computer readable program code further includes:
program code to generate a relative historical performance comparison involving at least one crop insurance plan according to at least one scenario.

94. The computer usable medium as recited in claim 90, wherein said computer readable program code further includes:
program code to determine historical performance of at least one crop insurance plan under at least one scenario.

95. The computer usable medium as recited in claim 90, wherein said computer readable program code further includes:
program code to (i) determine a projected and/or hypothetical performance of at least one crop insurance plan, based at least in part upon at least one assumption concerning at least one crop insurance plan variable, and/or (ii) determine a current actual performance of at least one crop insurance plan.

96. The computer usable medium as recited in claim 95, wherein said computer readable program code further includes:
program code to develop trending information, based at least in part upon the determination of projected and/or hypothetical performance.

97. The computer usable medium as recited in claim 90, wherein said computer readable program code further includes:
program code to define at least one hypothetical scenario for at least one crop insurance plan; and
program code to determine the behavior of at least one crop insurance plan in response to the at least one hypothetical scenario.

98. The computer usable medium as recited in claim 90, wherein said computer readable program code further includes:
program code to perform a business and/or financial analysis incorporating results from the crop insurance plan performance determination.

99. The computer usable medium as recited in claim 90, wherein said computer readable program code further includes:
program code for integrating multiple crop insurance plans into a consolidated quotation and management package to thereby enable an analysis of all available crop insurance plans.
